(19) United States
(12) Patent Application Publication
(10) Pub. No.: US 2025/0071799 A1
(43) Pub. Date: Feb. 27, 2025

(54) BROADCAST TRS CONFIGURATION

(71) Applicant: QUALCOMM Incorporated, San Diego, CA (US)

(72) Inventors: Navid ABEDINI, Basking Ridge, NJ (US); Aria HASANZADEZONUZY, Somerville, NJ (US); Junyi LI, Fairless Hills, PA (US); Tao LUO, San Diego, CA (US)

(21) Appl. No.: 18/455,549

(22) Filed: Aug. 24, 2023

(51) Int. Cl. H04W 72/563; H04L 5/00; H04W 28/02

(52) U.S. Cl. CPC H04W 72/563; H04L 5/0048; H04W 28/0215

(57) ABSTRACT

Apparatuses and methods for broadcast TRS configurations are described. An apparatus is configured to receive, from a network node, a first TRS configuration via a SIB. The apparatus is also configured to monitor, in a connected mode, a first resource for a TRS based on the first TRS configuration. The apparatus is also configured to perform a first set of TRS measurements for the TRS. Another apparatus is configured to provide, for a UE, a first TRS configuration, associated with a TRS for a connected mode of the UE, via a SIB. The apparatus is also configured to communicate, with the UE, based a first set of TRS measurements for the TRS that is associated with a monitored first resource of the TRS associated with the first TRS configuration.

### TECHNICAL FIELD

The present disclosure relates generally to communication systems, and more particularly, to wireless communications utilizing a tracking reference signal (TRS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may comprise a user equipment (UE), and the method may be performed at a UE. The apparatus is configured to receive, from a network node, a first tracking reference signal (TRS) configuration via a system information block (SIB). The apparatus is also configured to monitor, in a connected mode, a first resource for a TRS based on the first TRS configuration. The apparatus is also configured to perform a first set of TRS measurements for the TRS.

In the aspect, the method includes receiving, from a network node, a first TRS configuration via a SIB. The method also includes monitoring, in a connected mode, a first resource for a TRS based on the first TRS configuration. The method also includes performing a first set of TRS measurements for the TRS.

In another aspect of the disclosure, a method, a computer-readable medium, and an apparatus are provided. The apparatus is configured to provide, for a UE, a first TRS configuration, associated with a TRS for a connected mode of the UE, via a SIB. The apparatus is also configured to communicate, with the UE, based on a first set of TRS measurements for the TRS that is associated with a monitored first resource of the TRS associated with the first TRS configuration.

In the aspect, the method includes providing, for a UE, a first TRS configuration, associated with a TRS for a connected mode of the UE, via a SIB. The method also includes communicating, with the UE, based on a first set of TRS measurements for the TRS that is associated with a monitored first resource of the TRS associated with the first TRS configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram for wireless communications, in accordance with various aspects of the present disclosure.

FIG. 5 is a diagram illustrating an example of broadcast TRS configuration, in accordance with various aspects of the present disclosure.

FIG. 6 is a diagram illustrating an example of broadcast TRS configuration, in accordance with various aspects of the present disclosure.

FIG. 7 is a diagram illustrating an example of broadcast TRS configuration, in accordance with various aspects of the present disclosure.

FIG. 8 is a diagram illustrating an example of broadcast TRS configuration, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks, such as an LTE network and/or a 5G NR network, among other examples of wireless communication networks, may be designed to support communications between network nodes (e.g., base stations, gNBs, etc.) and UEs. For such communications, a TRS may be used for frequency and time tracking, estimation of channel delay spread and Doppler spread estimation, automatic gain control (AGC) and power delay profile (PDP) estimation, and/or the like. A TRS may be configured for a connected mode UE. For instance, UEs in RRC connected mode may be expected to receive the higher layer UE specific configuration of an NZP-CSI-RS-ResourceSet configured with a higher layer parameter trs-Info. For idle/inactive mode UEs, a SIB17 can carry cell-specific TRS configuration that can be used by idle/inactive UEs. In some deployments, TRS transmission is cell-specific, although the configuration of TRS may be provided using dedicated RRC signaling to connected UEs.

However, TRS transmission that is cell-specific for UEs in the connected mode with a network node and broadcast SIBs carrying TRS information creates wasteful redundancies in wireless transmissions. That is, scenarios arise in which TRS configurations are provided to a UE via a SIB, and then are provided again using dedicated RRC to connected UEs. Provision of the same TRS information multiple times to the same UE increases signaling overhead in wireless communication networks, introduces delay into the networks, and also increases power/processing consumption at UEs and network nodes.

Various aspects relate generally to wireless communications utilizing a TRS. Some aspects more specifically relate to broadcast TRS configuration. In one example, a UE may be configured to receive, from a network node, a first TRS configuration via a SIB. The UE may also be configured to monitor, in a connected mode, a first resource for a TRS based on the first TRS configuration. The UE may also be configured to perform a first set of TRS measurements for the TRS. In another example, a network node may be configured to provide, for a UE, a first TRS configuration, associated with a TRS for a connected mode of the UE, via a SIB. The network node may also be configured to receive, from the UE, a first indication of a first set of TRS measurements for the TRS based on a monitored first resource of the TRS associated with the first TRS configuration. Thus, aspects herein enable SIB17-based TRS configuration in the connected mode for UEs, as well as provide for configurations and considerations, such as dynamic reconfiguration due to network/device changes, to improve resource utilization and efficiency.

Particular aspects of the subject matter described in this disclosure can be implemented to realize one or more of the following potential advantages. In some examples, by enabling broadcast TRS configuration for UEs in connected mode, the described techniques can be used to reduce signaling overhead and power consumption without impacting UE performance. In some examples, by implementing dynamic features of SIB17 to activate/deactivate TRS, the described techniques can be used to improve flexibility and efficiency in reconfigurations due to network/device changes.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

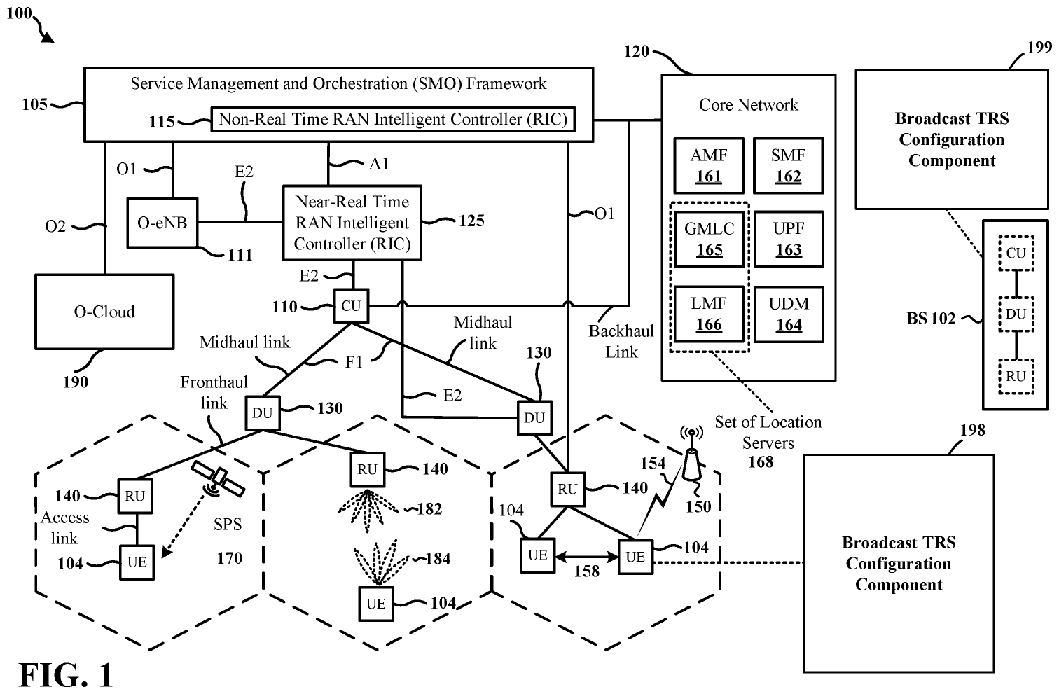

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110. the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a broadcast TRS configuration component 198 (“component 198”) that may be configured to receive, from a network node, a first TRS configuration via a SIB. The component 198 may also be configured to monitor, in a connected mode, a first resource for a TRS based on the first TRS configuration. The component 198 may also be configured to perform a first set of TRS measurements for the TRS. The component 198 may be configured to receive, from the network node, a second TRS configuration via RRC signaling. The component 198 may be configured to refrain from monitoring the first resource indicated in the first TRS configuration. The component 198 may be configured to monitor, in the connected mode, a second resource for the TRS based on the second TRS configuration. The component 198 may be configured to perform a second set of TRS measurements for the TRS based on the monitored second resource. The component 198 may be configured to receive, from the network node after the reception of the second TRS configuration, a priority indication that indicates a configuration prioritization associated with the first TRS configuration and the second TRS configuration. The component 198 may be configured to receive, from the network node, a second TRS configuration via RRC signaling. The component 198 may be configured to receive, from the network node, a priority indication that indicates a configuration prioritization associated with the first TRS configuration and the second TRS configuration. The component 198 may be configured to receive, from the network node, a second TRS configuration via RRC signaling, where the second TRS configuration indicates a second resource for the TRS. The component 198 may be configured to receive, from the network node, a priority indication that indicates a configuration prioritization associated with the first TRS configuration and the second TRS configuration. The component 198 may be configured to provide, to the network node, a capability indication of the UE, where the capability indication provides indicia of support of the UE for a paging error indication (PEI) and paging physical downlink control channel (PDCCH) monitoring in the connected mode. The component 198 may be configured to receive, from the network node, an activity indication associated with the first resource for the TRS that indicates an activation or a deactivation of the first resource for the TRS. The component 198 may be configured to receive, from the network node, a selection indication and an index associated with the SSB beam, where the index associated with the SSB beam corresponds to a transmission configuration indication (TCI) state configuration, where the selection indication corresponds to the one TRS resource set. The component 198 may be configured to apply the TCI state configuration based on the selection indication and the index associated with the SSB beam. The component 198 may be configured to receive, from the network node, a selection indication and an order value associated with an ordered location of the TRS resource set in the more than one TRS resource set, where the order value associated with the TRS resource set corresponds to a TCI state configuration, where the selection indication corresponds to the TRS resource set. The component 198 may be configured to apply the TCI state configuration based on the selection indication and the order value associated with the TRS resource set. The component 198 may be configured to receive, from the network node, a selection indication and the identifier of the TRS resource set, where the identifier of the TRS resource set corresponds to a TCI state configuration, where the selection indication corresponds to the TRS resource set. The component 198 may be configured to apply the TCI state configuration based on the selection indication and the identifier of the TRS resource set. The component 198 may be configured to communicate, with the network node, based on the first set of TRS measurements for the TRS. In certain aspects, the base station 102 may have a broadcast TRS configuration component 199 (“component 199”) that may be configured to provide, for a UE, a first TRS configuration, associated with a TRS for a connected mode of the UE, via a SIB. The component 199 may also be configured to communicate, with the UE, based on a first set of TRS measurements for the TRS that is associated with a monitored first resource of the TRS associated with the first TRS configuration. The component 199 may be configured to provide, for the UE, a second TRS configuration via RRC signaling. The component 199 may be configured to communicate, with the UE and absent further communication based on the first set of TRS measurements for the TRS, based on a second set of TRS measurements for the TRS that is associated with a monitored second resource of the TRS associated with the second TRS configuration. The component 199 may be configured to provide, for the UE, a priority indication that indicates a configuration prioritization associated with the first TRS configuration and the second TRS configuration. The component 199 may be configured to provide, for the UE, a second TRS configuration via RRC signaling. The component 199 may be configured to provide, for the UE, a priority indication that indicates a configuration prioritization associated with the first TRS configuration and the second TRS configuration. The component 199 may be configured to provide, for the UE, a second TRS configuration via RRC signaling, where the second TRS configuration indicates a second resource for the TRS. The component 199 may be configured to provide, for the UE, a priority indication that indicates a configuration prioritization associated with the first TRS configuration and the second TRS configuration. The component 199 may be configured to receive, from the UE, a capability indication of the UE, where the capability indication provides indicia of support of the UE for a PEI and paging PDCCH monitoring in the connected mode. The component 199 may be configured to provide, for the UE, an activity indication associated with the first resource for the TRS that indicates an activation or a deactivation of the first resource for the TRS. The component 199 may be configured to configure the UE with a TCI state configuration based on a selection indication and an index associated with the SSB beam by providing, for the UE, the selection indication and the index associated with the SSB beam, where the index associated with the SSB beam corresponds to the TCI state configuration, where the selection indication corresponds to the one TRS resource set. The component 199 may be configured to configure the UE with a TCI state configuration based on a selection indication and an order value associated with the TRS resource set, where to configure the UE with the TCI state configuration, the at least one processor, individually or in any combination, is configured to provide, for the UE, the selection indication and the order value associated with an ordered location of the TRS resource set in the more than one TRS resource set, where the order value associated with the TRS resource set corresponds to the TCI state configuration, where the selection indication corresponds to the TRS resource set. The component 199 may be configured to configure the UE with a TCI state configuration based on a selection indication and the identifier of the TRS resource set by providing, for the UE, the selection indication and the identifier of the TRS resource set, where the identifier of the TRS resource set corresponds to the TCI state configuration, where the selection indication corresponds to the TRS resource set. Accordingly, aspects herein enable SIB17-based TRS configuration in the connected mode for UEs, as well as provide for configurations and considerations, such as dynamic reconfiguration due to network/device changes, to improve resource utilization and efficiency.

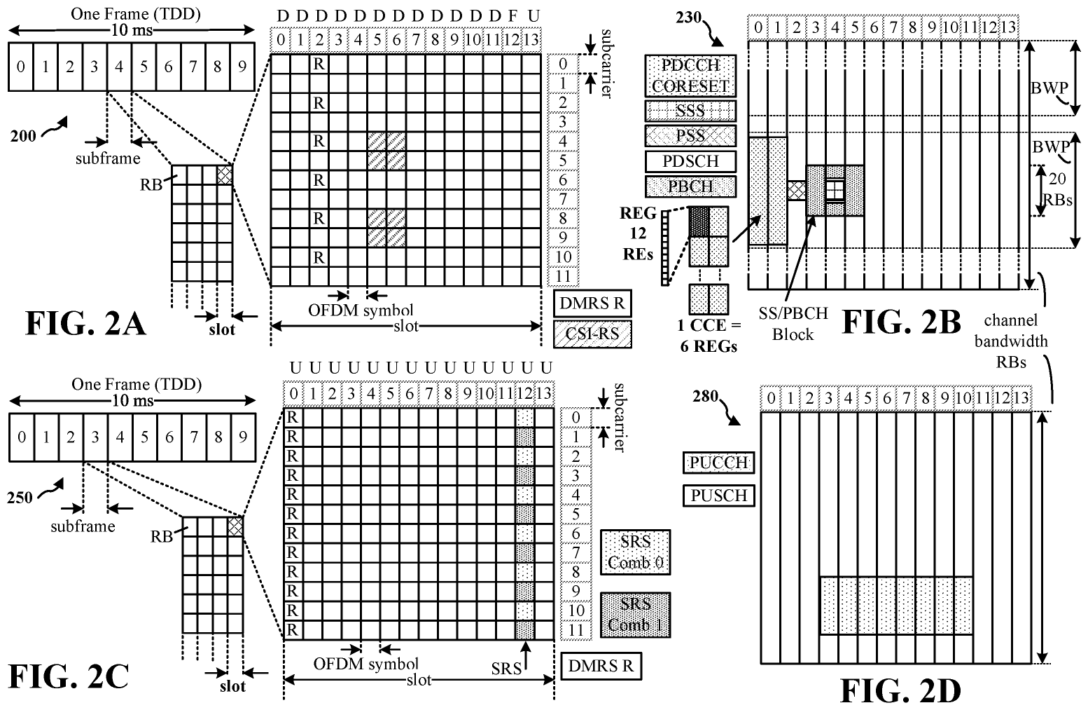

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2μ*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

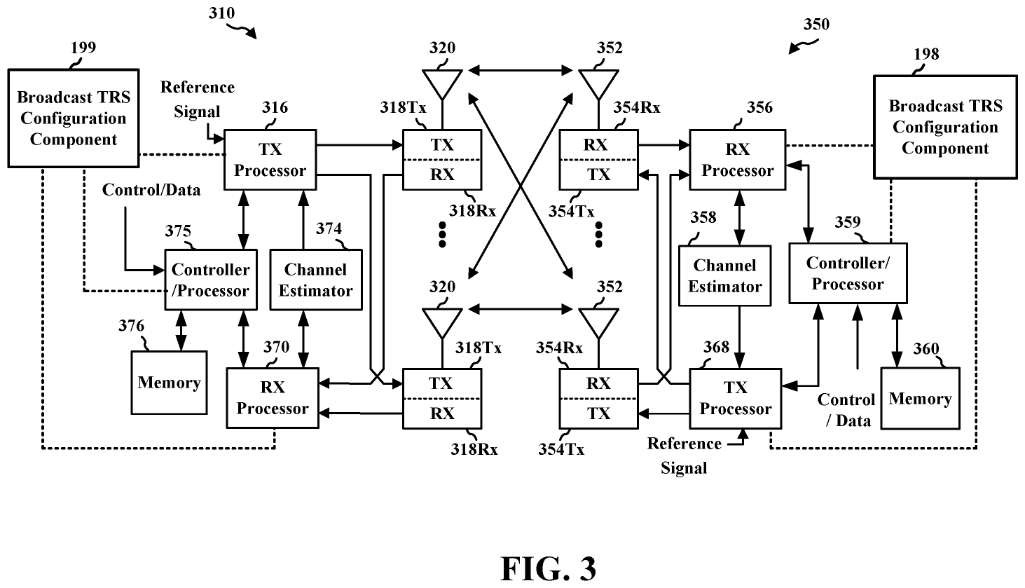

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving. rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

For communications between network nodes (e.g., base stations, gNBs, etc.) and UEs, a TRS may be used for frequency and time tracking, estimation of channel delay spread and Doppler spread estimation, AGC and power delay profile (PDP) estimation, and/or the like. A TRS may be configured for a connected mode UE. For instance, UEs in RRC connected mode may be expected to receive the higher layer UE specific configuration of an NZP-CSI-RS-ResourceSet configured with a higher layer parameter trs-Info. For idle/inactive mode UEs, a SIB17 can carry cell-specific TRS configuration that can be used by idle/inactive UEs. In some deployments, TRS transmission is cell-specific, although the configuration of TRS may be provided using dedicated RRC signaling to connected UEs. However, TRS transmission that is cell-specific for UEs in the connected mode with a network node and broadcast SIBs carrying TRS information creates wasteful redundancies in wireless transmissions. That is, scenarios arise in which TRS configurations are provided to a UE via a SIB, and then are provided again using dedicated RRC to connected UEs. Provision of the same TRS information multiple times to the same UE increases signaling overhead in wireless communication networks, introduces delay into the networks, and also increases power/processing consumption at UEs and network nodes.

An existing TRS may be used for AGC, delay spread, Doppler, as well for time frequency tracking measurements. Accordingly, UE specific configuration may be beneficial because these measurements (e.g., from TRS) should match those on the PDSCH. Because each UE may experience, for example, a different channel, it may/will experience different precoding, which may justify dedicated, and different, TRS as provided by the aspects herein. Aspects allow connected mode UEs to efficiently leverage SIB17 for TRS configuration.

In aspects, a TRS configuration may be a configuration that configures TRS resources (e.g., resource sets/groups) for monitoring by a UE to perform TRS measurements. The aspects herein for broadcast TRS configurations enable SIB17-based TRS configuration in the connected mode for UEs, as well as provide for configurations and considerations, such as dynamic reconfiguration due to network/device changes, to improve resource utilization and efficiency. Aspects reduce signaling overhead and power consumption without impacting UE performance by enabling broadcast TRS configuration for UEs in connected mode. For instance, if SIB17 is always or almost always being broadcast, e.g., for the purpose of idle/inactive mode UEs, the RRC configuration overhead for connected UEs may be reduced without negatively impacting the performance of the UE. This is beneficial for both the network ide and the UE side to improve resource utilization as well as reducing the power consumption, e.g., which may be substantial at the network side Further, impacts on connected mode UE power consumption may be realized. When semi-static broadcast of TRS configurations are utilized, there is no, or minimal, impact on UE power consumption. That is, either such a UE (before its connection) has already acquired SIB17 for its idle/inactive mode, or the UE after connecting would once acquire SIB17 (along with other SIBs).

Aspects also improve flexibility and efficiency in reconfigurations due to network/device changes by implementing dynamic features of SIB17 to activate/deactivate TRS. For instance, SIB17-based TRS allows utilization of built-in dynamic features (e.g., that allow turning ON-OFF the TRS). Leveraging such features, such as for connected UEs, enables more flexible/efficient system reconfigurations in response to changes in conditions including, without limitation, load, UE density, energy consumption limits, etc.

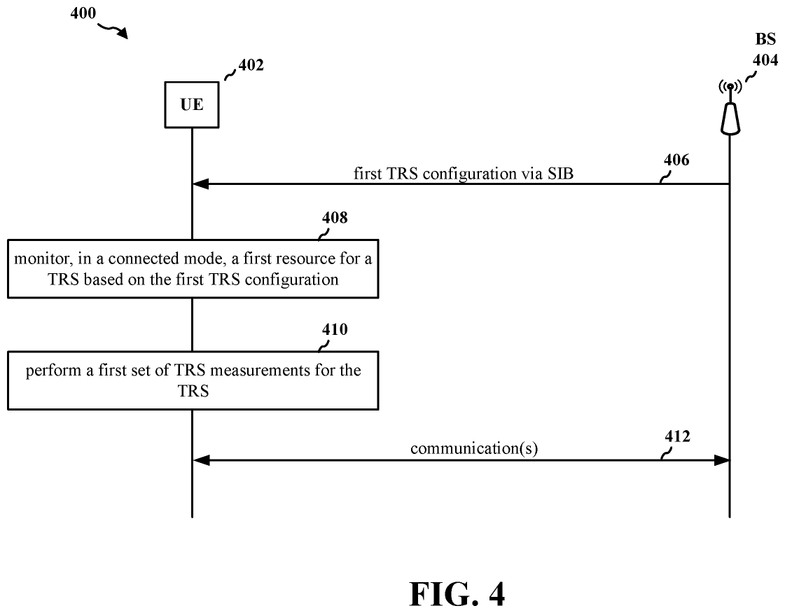

FIG. 4 is a call flow diagram 400 for wireless communications, in various aspects. Call flow diagram 400 illustrates broadcast TRS configurations for a wireless device (a UE 402, by way of example) that communicates with the network node (a base station 404, such as a gNB or other type of base station, by way of example, as shown), in various aspects. Aspects described for the base station 404 may be performed by the base station in aggregated form and/or by one or more components of the base station in disaggregated form. Additionally, or alternatively, the aspects may be performed by the UE 402 autonomously, in addition to, and/or in lieu of, operations of the base station 404. In aspects, the UE 402 may in the connected mode.

In the illustrated aspect, the UE 402 may be configured to receive, and the base station 404 may be configured to generate/transmit/provide, a first TRS configuration 406 via a SIB, e.g., SIB17. The first TRS configuration 406 may configure the UE 402 for TRS in the connected (or active) mode. In aspects, the UE 402 may be configured to, or may default to, always overriding a SIB17 configuration with a RRC message configuration if both SIB17 and a dedicated RRC message are present. In some aspects, such behavior may be configurable and indicated by the base station 404 to the UE 402 in connected mode. In certain aspects, if the UE 402 in connected mode does not receive a dedicated RRC message configuration, and is configured via SIB17, the UE 402 may assume periodic TRS resource sets or groups will be available at future times. These and other configuration details are described further below with reference to the additional FIGs.

The UE 402 may be configured to monitor (at 408), in the connected mode, a first resource for a TRS based on the first TRS configuration 406. In aspects, the first resource may be included in one or more resources sets, which may be comprised of different bandwidth parts on a given TRS.

Regarding aspects for TRS periodicity, SIB-17 TRS may not always be available (e.g., there may be a limited validity duration, dynamically turning ON/OFF via PEI or paging PDCCH indication, etc.). However, the UE 402 may expect periodic TRS while it is in the connected mode. According to aspects, the base station 404 may be configured with a specific provision to assure connected UEs, such as the UE 402 in the connected mode, have available the advertised TRS configuration in SIB-17 such that the TRS configurations are maintained as periodically available while the UEs are connected. In aspects, such provision enables the UE 402 to refrain from monitoring for PEI/paging PDCCH. Thus, the UE 402 may be configured to monitor (at 408) the first resource based on a TRS periodicity that may be associated with an absence of a second TRS configuration, a periodicity indication from the network node, etc. In aspects, the TRS periodicity may be based on an absence of a second TRS configuration (e.g., absence of a UE specific RRC message indicating a TRS configuration), where TRS periodicity for SIB17 may be inferred/assumed by the UE 402, based on the absence, where TRS resource sets may be received periodically. In some aspects, a periodicity indication from a network node, e.g., the base station 404, may be received by the UE 402, where the periodicity indication indicates the TRS periodicity. For example, the base station 404 may explicitly indicate to the UE 402 whether it can assume SIB17 TRS is always periodically available for the UE 402.

The UE 402 may be configured to perform (at 410) a first set of TRS measurements for the TRS. In other words, the first resource of the TRS that is monitored (at 408) may be the subject of the first set of TRS measurements performed by the UE 402. Put another way, performing (at 410) the first set of TRS measurements for the TRS may include performing (at 410) the first set of TRS measurements based on the monitored first resource (at 408).

The UE 402 may be configured to transmit/provide and/or receive, and the base station 404 may be configured to receive and/or transmit/provide, a communication(s) 412 based on the first set of TRS measurements for the TRS (e.g., at 410). For instance, subsequently, adjustments may be made for operations and/or communications associated with the UE 402 and/or the base station 404 based on one or more of frequency and time tracking, estimation of channel delay spread and Doppler spread estimation, AGC, PDP estimation, etc., that may be determined from the first set of TRS measurements. Accordingly, adjusted operations and/or communications may take place after an efficient/flexible TRS configuration, e.g., for CSI-RS provision by the base station 404 and reception by the UE 402, and reporting of CSI-RS measurements by the UE 402 to the base station 404.

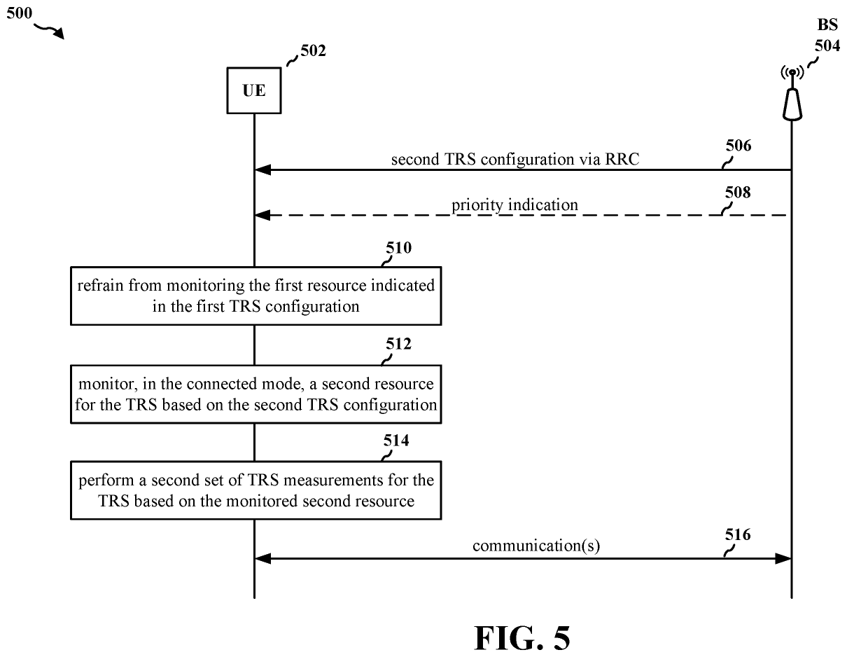

FIG. 5 is a diagram 500 illustrating an example of broadcast TRS configuration, in various aspects. Diagram 500 illustrates broadcast TRS configurations for a wireless device (a UE 502, by way of example) that communicates with the network node (a base station 504, such as a gNB or other type of base station, by way of example, as shown), in various aspects. Aspects described for the base station 504 may be performed by the base station in aggregated form and/or by one or more components of the base station in disaggregated form. Additionally, or alternatively, the aspects may be performed by the UE 502 autonomously, in addition to, and/or in lieu of, operations of the base station 504. In aspects, the UE 502 may in the connected mode. Diagram 500 may be a further or continuing aspect of call flow diagram 400 in FIG. 4. For instance, diagram 500 may show an example of the UE 502 being configured to override a SIB17 configuration with a RRC message configuration if both SIB17 and a dedicated RRC message are present.

In the illustrated aspect, the UE 502 may be configured to receive, and the base station 504 may be configured to generate/transmit/provide, a second TRS configuration 506. In aspects, the second TRS configuration 506 may be received via RRC signaling/messaging as a dedicated TRS configuration. The UE 502 may be configured to receive, and the base station 504 may be configured to generate/transmit/provide, a priority indication 508 priority indication 508 after the second TRS configuration 506. In aspects, the priority indication 508 may indicate a configuration prioritization associated with the first TRS configuration (e.g., the first TRS configuration 406 in FIG. 4) and the second TRS configuration 506.

The UE 502 may be configured to refrain (at 510) from monitoring the first resource indicated in the first TRS configuration. In aspects, the presence of the second TRS configuration 506 received from the base station 504 may override the first resource configuration (e.g., via SIB); that is, the UE 502 may be configured to override the first resource configuration if/when the second TRS configuration 506 is received in the connected mode. In some aspects, refraining (at 510) from monitoring the first resource may include refraining from monitoring the first resource based on the configuration prioritization indicated by the priority indication 508. That is, the UE 502 being configured to override a SIB17 configuration (e.g., the first TRS configuration 406 in FIG. 4) with a dedicated RRC message configuration (e.g., the second TRS configuration 506) if both SIB17 and a dedicated RRC message are present.

The UE 502 may be configured to monitor (at 512), in the connected mode, a second resource for the TRS based on the second TRS configuration 506. In aspects, the second resource may be included in one or more resources sets, which may be comprised of different bandwidth parts on a given TRS, and the second resource may be in the same resource set(s) as, or a different resource set(s) than, the first resource. Subsequently, the UE 502 may be configured to perform (at 514) a second set of TRS measurements for the TRS based on the monitored (at 512) second resource. That is, the second resource of the TRS that is monitored (at 512) may be the subject of the second set of TRS measurements performed (at 514) by the UE 502.

The UE 502 may be configured to transmit/provide and/or receive, and the base station 504 may be configured to receive and/or transmit/provide, a communication(s) 516 based on the second set of TRS measurements for the TRS (e.g., at 514). For instance, after the second set of TRS measurements are performed (at 514), adjustments may be made for operations and/or communications associated with the UE 502 and/or the base station 504 based on one or more of frequency and time tracking, estimation of channel delay spread and Doppler spread estimation, AGC, PDP estimation, etc., that may be determined from the second set of TRS measurements. Accordingly, adjusted operations and/or communications may take place after an efficient/flexible TRS configuration, e.g., for CSI-RS provision by the base station 504 and reception by the UE 502, and reporting of CSI-RS measurements by the UE 502 to the base station 504.

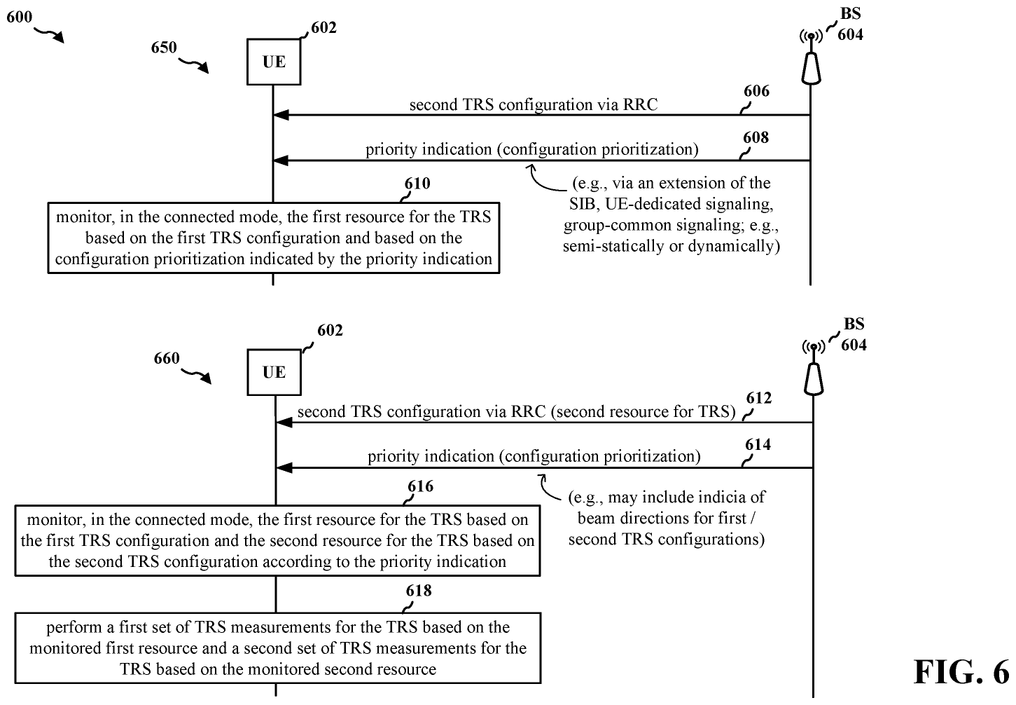

FIG. 6 is a diagram 600 illustrating an example of broadcast TRS configuration, in various aspects. Diagram 600 shows a configuration 650 and a configuration 660 for broadcast TRS configurations for a wireless device (a UE 602, by way of example) that communicates with the network node (a base station 604, such as a gNB or other type of base station, by way of example, as shown), in various aspects. Aspects described for the base station 604 may be performed by the base station in aggregated form and/or by one or more components of the base station in disaggregated form. Additionally, or alternatively, the aspects may be performed by the UE 602 autonomously, in addition to, and/or in lieu of, operations of the base station 604. In aspects, the UE 602 may in the connected mode. Diagram 600 may be a further or continuing aspect of call flow diagram 400 in FIG. 4 and/or diagram 500 in FIG. 5. For instance, diagram 600 may show an example of the UE 602 being configurable by the base station 604 for TRS configuration behaviors that consider SIB17 configuration and/or RRC message configuration based on indications if both SIB17 and a dedicated RRC message are present.

In the illustrated aspect for the configuration 650, the UE 602 may be configured to receive, and the base station 604 may be configured to generate/transmit/provide, a second TRS configuration 606. In aspects, the second TRS configuration 606 may be received via RRC signaling/messaging as a dedicated TRS configuration. The UE 602 may be configured to receive, and the base station 604 may be configured to generate/transmit/provide, a priority indication 608 after the second TRS configuration 606. In aspects, the priority indication 608 may indicate a configuration prioritization associated with the first TRS configuration (e.g., the first TRS configuration 406 in FIG. 4) and the second TRS configuration 606. The configuration prioritization of the priority indication 608 may indicate, in aspects, that the first TRS configuration or the second TRS configuration 606 has priority for configuring TRS at the UE 602. In the illustrated aspect, the configuration prioritization of the priority indication 608 may indicate that the first TRS configuration has priority over the second TRS configuration 606 even though the second TRS configuration 606 is received via direct RRC messaging in the connected mode for the UE 602. The priority indication 608 may be received by the UE 602, and transmitted/provided from the base station 604, via an extension of the SIB17, UE-dedicated signaling. group-common signaling, and/or the like, in aspects. Additionally, the priority indication 608 may be received and transmitted/provided semi-statically or dynamically, in some aspects.

The UE 602 may be configured to monitor (at 610), in the connected mode, the first resource for the TRS based on the first TRS configuration (e.g., the first TRS configuration 406 in FIG. 4) and based on the configuration prioritization indicated by the priority indication 608. Subsequently, the UE 602 may be configured to perform (e.g., as described at 410 in FIG. 4) a first set of TRS measurements for the TRS and transmit/provide and/or receive, which the base station 604 may be configured to reciprocally receive and/or transmit/provide, one or more communications (e.g., the communication(s) 412 in FIG. 4) based on the first set of TRS measurements for the TRS.

Accordingly, when contrasting diagram 500 of FIG. 5 noted above with the configuration 650 of FIG. 6, aspects herein provide for efficient/flexible configuration options in scenarios for which consideration of either SIB17 TRS configuration or dedicated RRC TRS configuration when both are present at a UE (e.g., when SIB17 and dedicated RRC messaging configure TRS on the same resources).

In the illustrated aspect for the configuration 660, the UE 602 may be configured to receive, and the base station 604 may be configured to generate/transmit/provide, a second TRS configuration 612. In aspects, the second TRS configuration 612 may be received via RRC signaling/messaging as a dedicated TRS configuration. The second TRS configuration 612 may include/indicate a second resource for the TRS. The UE 602 may be configured to receive, and the base station 604 may be configured to generate/transmit/provide, a priority indication 614 after the second TRS configuration 612. In some aspects, the priority indication 614 may include a first indication of a first beam direction associated with the first TRS configuration (e.g., the first TRS configuration 406 in FIG. 4) and a second indication of a second beam direction associated with the second TRS configuration 612. That is, the priority indication 614 may indicate priorities for TRS configurations that are beam-specific, e.g., for some beam directions, SIB17 configurations may be used (e.g., the first TRS configuration 406 in FIG. 4), while for some other beam directions, dedicated RRC configurations may be used (e.g., the second TRS configuration 606).

The UE 602 may be configured to monitor (at 616), in the connected mode, the first resource for the TRS based on the first TRS configuration (e.g., the first TRS configuration 406 in FIG. 4) and the second resource for the TRS based on the second TRS configuration 612 according to the priority indication 614. In aspects, such a union of the first TRS configuration and the second TRS configuration 612, the first resource and the second may be included in one or more resources sets, which may be the same or different resource sets, and which may comprise different bandwidth parts on a given TRS.

The UE 602 may be configured to perform (at 618) a first set of TRS measurements for the TRS based on the monitored (at 616; e.g., at 408 in FIG. 4) first resource and a second set of TRS measurements for the TRS based on the monitored (at 616) second resource. That is, the first and second resources of the TRS that are monitored (at 616) may be the subject of the first and second sets of TRS measurements performed (at 619) by the UE 602. Subsequently, the UE 602 may be configured to transmit/provide and/or receive, which the base station 604 may be configured to reciprocally receive and/or transmit/provide, one or more communications (e.g., the communication(s) 412 in FIG. 4) based on the first set of TRS measurements for the TRS.

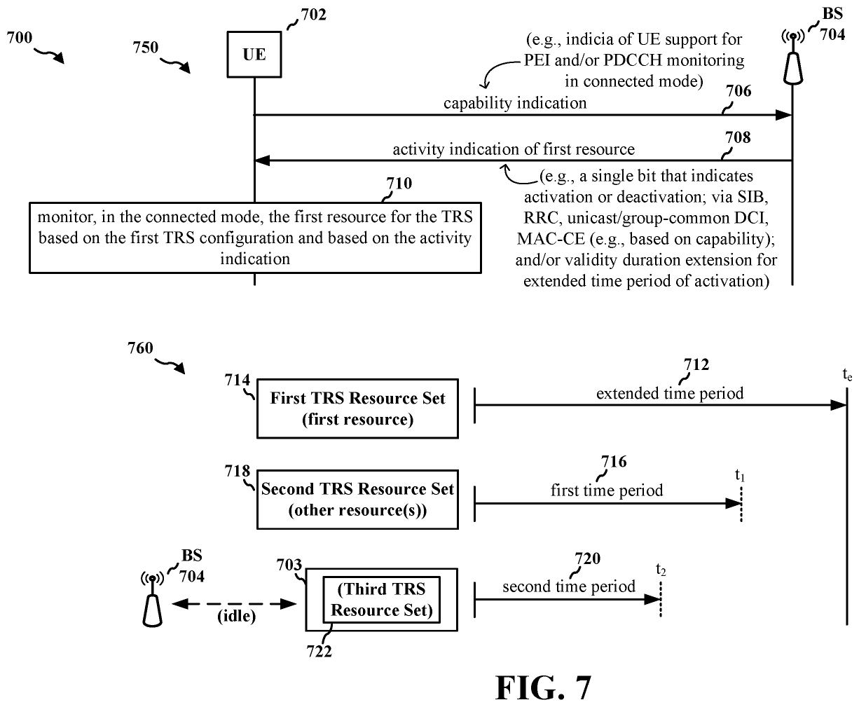

FIG. 7 is a diagram 700 illustrating an example of broadcast TRS configuration, in various aspects. Diagram 700 shows a configuration 750 and a configuration 760 for broadcast TRS configurations for a wireless device (a UE 702, by way of example) that communicates with the network node (a base station 704, such as a gNB or other type of base station, by way of example, as shown), in various aspects. Aspects described for the base station 704 may be performed by the base station in aggregated form and/or by one or more components of the base station in disaggregated form. Additionally, or alternatively, the aspects may be performed by the UE 702 autonomously, in addition to, and/or in lieu of, operations of the base station 704. In aspects, the UE 702 may in the connected mode. Diagram 700 may be a further or continuing aspect of call flow diagram 400 in FIG. 4, diagram 500 in FIG. 5, and/or diagram 600 in FIG. 6. For instance, diagram 700 may show an example of the UE 702 being configurable by the base station 704 for TRS configuration behaviors for activation/deactivation of TRS for SIB17 configurations based on UE capability indications.

As noted above for TRS periodicity, SIB-17 TRS may not always be available (e.g., there may be a limited validity duration, dynamically turning ON/OFF via PEI or paging PDCCH indication, etc.). However, a UE may expect periodic TRS while it is in the connected mode. According to aspects, a network node (e.g., a base station, gNB, etc.) may be configured with a specific provision to assure connected UEs have available the advertised TRS configuration in SIB-17 such that the TRS configurations are maintained as periodically available while the UEs are connected. In aspects, such provision enables the UEs to refrain from monitoring for PEI/paging PDCCH. Thus, a UE may be configured to monitor TRS resources based on a TRS periodicity that may be associated with an absence of a second TRS configuration, a periodicity indication from the network node, etc. In aspects, the TRS periodicity may be based on an absence of a second TRS configuration (e.g., absence of a UE specific RRC message indicating a TRS configuration), where TRS periodicity for SIB17 may be inferred/assumed by a UE, based on the absence, where TRS resource sets may be received periodically. In some aspects, a periodicity indication from a network node, where the periodicity indication indicates the TRS periodicity. For example, the base station 704 may explicitly indicate to the UE 702 whether it can assume SIB17 TRS is always periodically available for the UE 702.

Aspects also provide support for separate activation/deactivation indication to connected UEs (e.g., which may avoid the complexity of PEI/paging PDCCH monitoring while in the connected mode). For instance, the base station 704 may indicate to the UE 702, while in the connected mode, whether a specific configured TRS resource set (group) is always active or not. In aspects, this indication may be provided by one bit, and may be in either SIB17, in dedicated RRC message, or in both. For activation, aspects enable the validity duration indication to include an extended time of activation for one or more, or each, TRS resource set in SIB17, rather than having one fixed validity duration for a TRS resource set in SIB17. thus, different validity durations for each resource group in SIB17 may be configured by the base station 704 for the UE 702. Further, TRS grouping may be applied differently from idle/inactive UEs, e.g., as group common with larger groups, or UE specific. Additionally, a connected UE may be configured to indicate to the network whether it supports PEI and/or paging DCI monitoring to check availability indications. For connected UEs that do not, or are not, monitoring PEI and/or paging DCI, aspects provide for indications of TRS availability to such UEs via DCI and/or MAC-CE.

In the illustrated aspect for the configuration 750, the UE 702 may be configured to transmit/provide, and the base station 704 may be configured to receive, a capability indication 706. The capability indication 706 may indicate/provides indicia of support, or lack for support, of the UE 702 for a PEI and/or paging PDCCH monitoring in the connected mode. The UE 702 may be configured to receive, and the base station 704 may be configured to transmit/provide, an activity indication 708 that is associated with the first resource for the TRS (e.g., based on the first TRS configuration 406 in FIG. 4) that indicates an activation or a deactivation of the first resource for the TRS. In aspects, the base station 404 may be configured to transmit/provide the activity indication 708 in response to, or based on, the capability indication 706. The activity indication 708 associated with the first resource for the TRS may be based on the capability indication 706 of the UE 702 indicating a lack of the support. In such cases, the activity indication 708 associated with the first resource for the TRS may be may be received by UE 702, and may be transmitted/provided by the base station 704, via unicast or group-common DCI or via a unicast or multi-cast medium access control (MAC) control element (MAC-CE).

In aspects, the activity indication 708 may include a single bit that indicates the activation or the deactivation for the first resource of the TRS. The UE 702 may be configured to receive, and the base station 704 may be configured to transmit/provide, the activity indication 708 the SIB (e.g., SIB17) and/or RRC signaling.

The UE 702 may be configured to monitor (at 710) the first resource for the TRS based on the first TRS configuration (e.g., the first TRS configuration 406 in FIG. 4) and based on the activity indication 708. Subsequently, the UE 702 may be configured to perform (e.g., as described at 410 in FIG. 4) a first set of TRS measurements for the TRS and transmit/provide and/or receive, which the base station 604 may be configured to reciprocally receive and/or transmit/provide, one or more communications (e.g., the communication(s) 412 in FIG. 4) based on the first set of TRS measurements for the TRS.

In the context of the illustrated aspect for the configuration 760, aspects provide that the activity indication 708 may include a validity duration extension that indicates an extended time period 712 for which a first TRS resource set 714 that includes the first resource of the TRS is activated (e.g., by the activity indication 708), as described in further detail below. For example, in the configuration 760, the UE 602 may be configured for the extended time period 712 associated with the first TRS resource set 714, as indicated in the activity indication 708. As noted, the UE 702 may be configured to receive, and the base station 704 may be configured to generate/transmit/provide, the activity indication 708 that may include a validity duration extension indicating the extended time period 712. That is, the base station 704 may activate the first TRS resource set 714 with the first TRS resource for a specific period of time tₑ (as the extended time period 712), which may be longer, or different, from other activated time periods.

For instance, the extended time period 712 may be different from a first time period 716 to a time t₁ that is associated with a first activation of a second TRS resource set 718 that excludes the first resource of the TRS (e.g., an includes one or more other resources). The extended time period 712 may, also or alternatively, be different from a second time period 720 to a time t₂ that is associated with a second activation of a third TRS resource set 722 of a different UE 703 in an idle mode with respect to the base station 704.

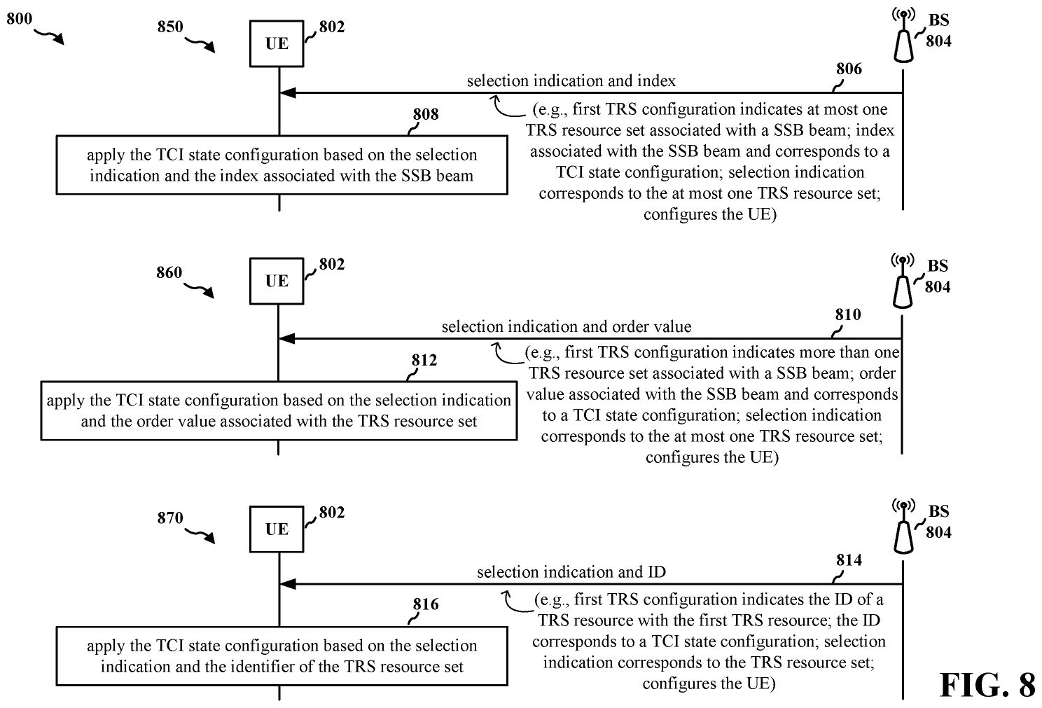

FIG. 8 is a diagram 800 illustrating an example of broadcast TRS configuration, in various aspects. Diagram 800 shows a configuration 850, a configuration 860, and a configuration 870 for broadcast TRS configurations for a wireless device (a UE 802, by way of example) that communicates with the network node (a base station 804, such as a gNB or other type of base station, by way of example, as shown), in various aspects. Aspects described for the base station 804 may be performed by the base station in aggregated form and/or by one or more components of the base station in disaggregated form. Additionally, or alternatively, the aspects may be performed by the UE 802 autonomously, in addition to, and/or in lieu of, operations of the base station 804. In aspects, the UE 802 may in the connected mode. Diagram 800 may be a further or continuing aspect of call flow diagram 400 in FIG. 4, diagram 500 in FIG. 5, diagram 600 in FIG. 6, and/or diagram 700 in FIG. 7. For instance, diagram 800 may show an example of the UE 802 being configurable by the base station 804 for TRS configuration behaviors that consider SIB17 configuration based on indications of beam-resource associations and SIB17 fields for resource identifiers (IDs).

For instance, aspects herein consider how to define TCI states with quasi co-location (QCL) relation to idle/broadcast TRS resources. That is, for some solutions, a TRS (e.g., configured via dedicated RRC) may be used as a reference for a TCI state configuration, where a CSI-RS resource index is used for the reference. However, if SIB-17/broadcast TRS is used for TCI state configuration, as in aspects herein, there is no current way to achieve such indexing as indexes/IDs of resources (or a set(s) thereof) are not explicitly configured in SIB-17. Accordingly, aspects provide solutions to such issues.

In the illustrated aspect for the configuration 850, if there is at most one TRS resource set per SSB beam as configured in SIB17, and the first resource, as described herein is included in the TRS resource set, then the network may use a SSB beam index to point to that TRS resource set.

For instance, where the first TRS configuration (e.g., the first TRS configuration 406 in FIG. 4) indicates at most one TRS resource set is associated with a SSB beam, and where the at most one TRS resource set includes the first TRS resource, the UE 802 may be configured to receive, and the base station 804 may be configured to transmit/provide, a selection indication and index 806 that includes a selection indication and an index. In aspects, the selection indication and index 806 may be associated with the SSB beam, the index associated with the SSB beam may correspond to a TCI state configuration, and the selection indication may correspond to the at most one TRS resource set. In some aspects, the base station 804 may provide, with the selection indication and index 806 or separately, a flag or another type of indication, such as a “choice” indication, while configuring a TCI state to indicate the reference is a SIB-17 TRS resource set.

The UE 802 may be configured to apply (at 808) the TCI state configuration based on the selection indication and the index associated with the SSB beam of the selection indication and index 806. Accordingly, the UE 802 may be configured by the base station 804, e.g., via the application of the TCI state configuration (at 808).

In the illustrated aspect for the configuration 860, if there are more than one TRS resource sets configured with each SSB beam in SIB17, then the network may use an integer or other sequential designator to refer to the order of the TRS resource set as configured in SIB17. In such a configuration, an explicit inclusion of an index/ID in SIB-17 may be avoided or refrained from. As one example, when there are three TRS resource sets configured in SIB17, the order of the resources sets in the SIB17 is clear to a UE, and if the network indicates “TRS 1,” where ‘1’ is an integer designator for order, the UE may be configured to infer that that the network refers to the first TRS resource set configured in SIB17.

For instance, where the first TRS configuration (e.g., the first TRS configuration 406 in FIG. 4) indicates more than one TRS resource set is associated with a SSB beam, and where a TRS resource set of the more than one TRS resource set includes the first TRS resource, the UE 802 may be configured to receive, and the base station 804 may be configured to transmit/provide, a selection indication and order value 810 that includes a selection indication and an order value. In aspects, the selection indication and order value 810 may be associated with an ordered location of the TRS resource set in the more than one TRS resource set(s), the order value associated with the TRS resource set may correspond to a TCI state configuration, and the selection indication may correspond to the TRS resource set.

The UE 802 may be configured to apply (at 812) the TCI state configuration based on the selection indication and the order value associated with the TRS resource set of the selection indication and order value 810. Accordingly, the UE 802 may be configured by the base station 804, e.g., via the application of the TCI state configuration (at 808).

In the illustrated aspect for the configuration 870, a new field may be included in SIB17 to identify or name TRS resource sets configured in SIB17, e.g., TRS-ResourceSet-r17Id. Thus, the network may be configured to provide an explicit ID of the TRS configuration to be used via SIB17.

For instance, where the first TRS configuration (e.g., the first TRS configuration 406 in FIG. 4) indicates an identifier of a TRS resource set that includes the first TRS resource, the UE 802 may be configured to receive, and the base station 804 may be configured to transmit/provide, a selection indication and identifier (ID) 814, where the selection indication and ID 814 includes a selection indication and an ID of the TRS resource set. In aspects, the ID of the TRS resource set may correspond to a TCI state configuration, and the selection ID may correspond to the TRS resource set.

The UE 802 may be configured to apply (at 816) the TCI state configuration based on the selection indication and the ID 814 of the TRS resource set. Accordingly, the UE 802 may be configured by the base station 804, e.g., via the application of the TCI state configuration (at 816).

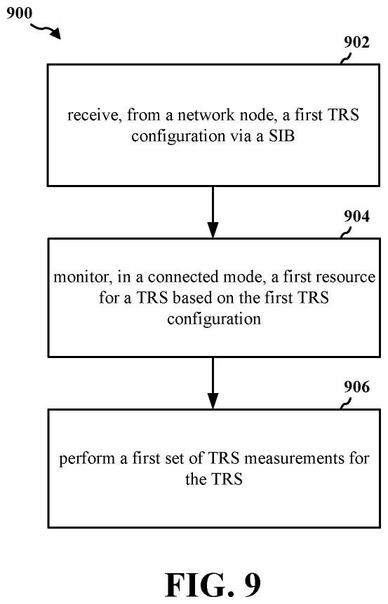

FIG. 9 is a flowchart 900 of a method of wireless communication, in various aspects. The method may be performed by a UE (e.g., the UE 104, 402, 502, 602, 702, 802; the apparatus 1104). In some aspects, the method may include aspects described in connection with the communication flow in FIG. 4 and/or aspects described in FIGS. 6, 7. The method may be for broadcast TRS configuration and enables SIB17-based TRS configuration in the connected mode for UEs, as well as provides for configurations and considerations, such as dynamic reconfiguration due to network/device changes, to improve resource utilization and efficiency.

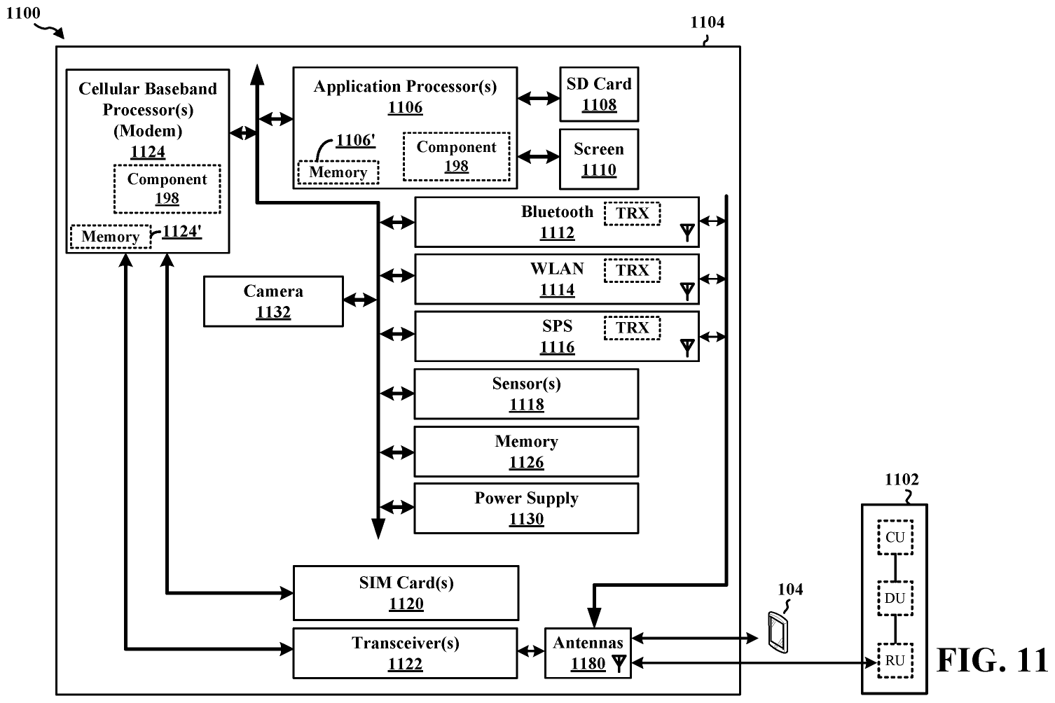

In 902, the UE receives, from a network node, a first TRS configuration via a SIB. As an example, the reception may be performed by one or more of the component 198, the transceiver 1122, and/or the antenna 1180 in FIG. 11. FIG. 4 illustrates an example of the UE 402 receiving such a TRS configuration via a SIB from a network node (e.g., the base station 404).

The UE 402 may be configured to receive, and the base station 404 may be configured to generate/transmit/provide, a first TRS configuration 406 via a SIB, e.g., SIB17. The first TRS configuration 406 may configure the UE 402 for TRS in the connected (or active) mode. In aspects, the UE 402 may be configured to, or may default to, always overriding a SIB17 configuration with a RRC message configuration if both SIB17 and a dedicated RRC message are present. In some aspects, such behavior may be configurable and indicated by the base station 404 to the UE 402 in connected mode. In certain aspects, if the UE 402 in connected mode does not receive a dedicated RRC message configuration, and is configured via SIB17, the UE 402 may assume periodic TRS resource sets or groups will be available at future times, as described herein.

In 904, the UE monitors, in a connected mode, a first resource for a TRS based on the first TRS configuration. As an example, the monitoring may be performed by one or more of the component 198, the transceiver 1122, and/or the antenna 1180 in FIG. 11. FIGS. 4, 6, 7 illustrate an example of the UE 402 monitoring such a resource for a TRS.

The UE 402 may be configured to monitor (at 408) (e.g., 610, 616 in FIG. 6; 710 in FIG. 7), in the connected mode, a first resource for a TRS based on the first TRS configuration 406. In aspects, the first resource may be included in one or more resources sets, which may be comprised of different bandwidth parts on a given TRS.

Regarding aspects for TRS periodicity, SIB-17 TRS may not always be available (e.g., there may be a limited validity duration, dynamically turning ON/OFF via PEI or paging PDCCH indication, etc.). However, the UE 402 may expect periodic TRS while it is in the connected mode. According to aspects, the base station 404 may be configured with a specific provision to assure connected UEs, such as the UE 402 in the connected mode, have available the advertised TRS configuration in SIB-17 such that the TRS configurations are maintained as periodically available while the UEs are connected. In aspects, such provision enables the UE 402 to refrain from monitoring for PEI/paging PDCCH. Thus, the UE 402 may be configured to monitor (at 408) (e.g., 610, 616 in FIG. 6; 710 in FIG. 7) the first resource based on a TRS periodicity that may be associated with an absence of a second TRS configuration, a periodicity indication from the network node, etc. In aspects, the TRS periodicity may be based on an absence of a second TRS configuration (e.g., absence of a UE specific RRC message indicating a TRS configuration), where TRS periodicity for SIB17 may be inferred/assumed by the UE 402, based on the absence, where TRS resource sets may be received periodically. In some aspects, a periodicity indication from a network node, e.g., the base station 404, may be received by the UE 402, where the periodicity indication indicates the TRS periodicity. For example, the base station 404 may explicitly indicate to the UE 402 whether it can assume SIB17 TRS is always periodically available for the UE 402.

In 906, the UE performs a first set of TRS measurements for the TRS. As an example, the measurements may be performed by one or more of the component 198, the transceiver 1122, and/or the antenna 1180 in FIG. 11. FIGS. 4-8 illustrate an example of the UE 402 performing such measurements.

The UE 402 may be configured to perform (at 410) (e.g., 618 in FIG. 6) a first set of TRS measurements for the TRS. In other words, the first resource of the TRS that is monitored (at 408) (e.g., 610, 616 in FIG. 6; 710 in FIG. 7) may be the subject of the first set of TRS measurements performed by the UE 402. Put another way, performing (at 410) (e.g., 618 in FIG. 6) the first set of TRS measurements for the TRS may include performing (at 410) (e.g., 618 in FIG. 6) the first set of TRS measurements based on the monitored first resource (at 408) (e.g., 610, 616 in FIG. 6; 710 in FIG. 7).

The UE 402 may be configured transmit/provide and/or receive, and the base station 404 may be configured to receive and/or transmit/provide, a communication(s) 412 based on the first set of TRS measurements for the TRS (e.g., at 410). For instance, subsequently, adjustments may be made for operations and/or communications associated with the UE 402 and/or the base station 404 based on one or more of frequency and time tracking, estimation of channel delay spread and Doppler spread estimation, AGC, PDP estimation, etc., that may be determined from the first set of TRS measurements. Accordingly, adjusted operations and/or communications may take place after an efficient/flexible TRS configuration, e.g., for CSI-RS provision by the base station 404 and reception by the UE 402, and reporting of CSI-RS measurements by the UE 402 to the base station 404.

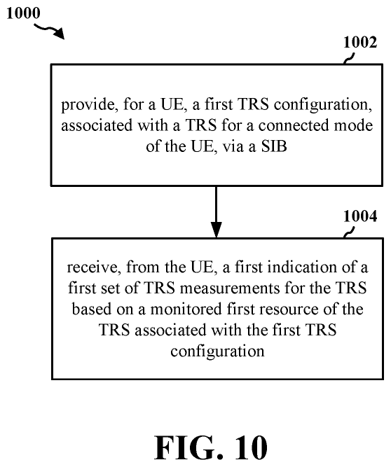

FIG. 10 is a flowchart 1000 of a method of wireless communication, in various aspects. The method may be performed by a network node (e.g., the base station 102, 404, 504, 604, 704, 804; the network entity 1102, 1202). In some aspects, the method may include aspects described in connection with the communication flow in FIG. 4 and/or aspects described in FIGS. 6, 7. The method may be for broadcast TRS configuration and enables SIB17-based TRS configuration in the connected mode for UEs, as well as provides for configurations and considerations, such as dynamic reconfiguration due to network/device changes, to improve resource utilization and efficiency.

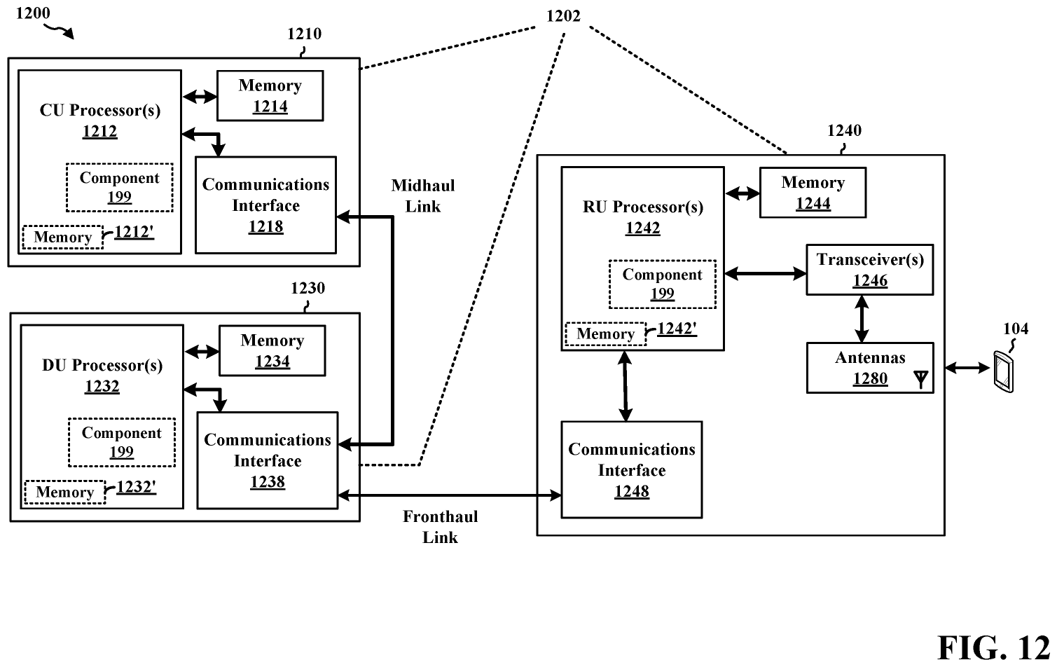

In 1002, the network node provides, for a UE, a first TRS configuration, associated with a TRS for a connected mode of the UE, via a SIB. As an example, the provision may be performed, at least in part, by one or more of the component 199, the transceiver(s) 1246, and/or the antenna(s) 1280 in FIG. 12. FIGS. 4-8 illustrate an example of a network node (e.g., the base station 404) providing such a TRS configuration via a SIB for a UE (e.g., the UE 402).

The UE 402 may be configured to receive, and the base station 404 may be configured to generate/transmit/provide, a first TRS configuration 406 via a SIB, e.g., SIB17. The first TRS configuration 406 may configure the UE 402 for TRS in the connected (or active) mode. In aspects, the UE 402 may be configured to, or may default to, always overriding a SIB17 configuration with a RRC message configuration if both SIB17 and a dedicated RRC message are present. In some aspects, such behavior may be configurable and indicated by the base station 404 to the UE 402 in connected mode. In certain aspects, if the UE 402 in connected mode does not receive a dedicated RRC message configuration, and is configured via SIB17, the UE 402 may assume periodic TRS resource sets or groups will be available at future times, as described herein.

In 1004, the network node receives, from the UE, a first indication of a first set of TRS measurements for the TRS based on a monitored first resource of the TRS associated with the first TRS configuration.

The UE 402 may be configured to transmit/provide and/or receive, and the base station 404 may be configured to receive and/or transmit/provide, a communication(s) 412 based on the first set of TRS measurements for the TRS (e.g., at 410). The UE 402 may be configured to monitor (at 408) (e.g., 610, 616 in FIG. 6; 710 in FIG. 7), in the connected mode, a first resource for a TRS based on the first TRS configuration 406. In aspects, the first resource may be included in one or more resources sets, which may be comprised of different bandwidth parts on a given TRS. Regarding aspects for TRS periodicity, SIB-17 TRS may not always be available (e.g., there may be a limited validity duration, dynamically turning ON/OFF via PEI or paging PDCCH indication, etc.). However, the UE 402 may expect periodic TRS while it is in the connected mode. According to aspects, the base station 404 may be configured with a specific provision to assure connected UEs, such as the UE 402 in the connected mode, have available the advertised TRS configuration in SIB-17 such that the TRS configurations are maintained as periodically available while the UEs are connected. In aspects, such provision enables the UE 402 to refrain from monitoring for PEI/paging PDCCH. Thus, the UE 402 may be configured to monitor (at 408) (e.g., 610, 616 in FIG. 6; 710 in FIG. 7) the first resource based on a TRS periodicity that may be associated with an absence of a second TRS configuration, a periodicity indication from the network node, etc. In aspects, the TRS periodicity may be based on an absence of a second TRS configuration (e.g., absence of a UE specific RRC message indicating a TRS configuration), where TRS periodicity for SIB17 may be inferred/assumed by the UE 402, based on the absence, where TRS resource sets may be received periodically. In some aspects, a periodicity indication from a network node, e.g., the base station 404, may be received by the UE 402, where the periodicity indication indicates the TRS periodicity. For example, the base station 404 may explicitly indicate to the UE 402 whether it can assume SIB17 TRS is always periodically available for the UE 402. The UE 402 may be configured to perform (at 410) (e.g., 618 in FIG. 6) a first set of TRS measurements for the TRS. In other words, the first resource of the TRS that is monitored (at 408) (e.g., 610, 616 in FIG. 6; 710 in FIG. 7) may be the subject of the first set of TRS measurements performed by the UE 402. Put another way, performing (at 410) (e.g., 618 in FIG. 6) the first set of TRS measurements for the TRS may include performing (at 410) (e.g., 618 in FIG. 6) the first set of TRS measurements based on the monitored first resource (at 408) (e.g., 610, 616 in FIG. 6; 710 in FIG. 7).

The UE 402 may be configured to transmit/provide and/or receive, and the base station 404 may be configured to receive and/or transmit/provide, a communication(s) 412 based on the first set of TRS measurements for the TRS (e.g., at 410). For instance, subsequently, adjustments may be made for operations and/or communications associated with the UE 402 and/or the base station 404 based on one or more of frequency and time tracking, estimation of channel delay spread and Doppler spread estimation, AGC, PDP estimation, etc., that may be determined from the first set of TRS measurements. Accordingly, adjusted operations and/or communications may take place after an efficient/flexible TRS configuration, e.g., for CSI-RS provision by the base station 404 and reception by the UE 402, and reporting of CSI-RS measurements by the UE 402 to the base station 404.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106. causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to receive, from a network node, a first TRS configuration via a SIB. The component 198 may also be configured to monitor, in a connected mode, a first resource for a TRS based on the first TRS configuration. The component 198 may also be configured to perform a first set of TRS measurements for the TRS. The component 198 may be configured to receive, from the network node, a second TRS configuration via RRC signaling. The component 198 may be configured to refrain from monitoring the first resource indicated in the first TRS configuration. The component 198 may be configured to monitor, in the connected mode, a second resource for the TRS based on the second TRS configuration. The component 198 may be configured to perform a second set of TRS measurements for the TRS based on the monitored second resource. The component 198 may be configured to receive, from the network node after the reception of the second TRS configuration, a priority indication that indicates a configuration prioritization associated with the first TRS configuration and the second TRS configuration. The component 198 may be configured to receive, from the network node, a second TRS configuration via RRC signaling. The component 198 may be configured to receive, from the network node, a priority indication that indicates a configuration prioritization associated with the first TRS configuration and the second TRS configuration. The component 198 may be configured to receive, from the network node, a second TRS configuration via RRC signaling, where the second TRS configuration indicates a second resource for the TRS. The component 198 may be configured to receive, from the network node, a priority indication that indicates a configuration prioritization associated with the first TRS configuration and the second TRS configuration. The component 198 may be configured to provide, to the network node, a capability indication of the UE, where the capability indication provides indicia of support of the UE for a PEI and paging PDCCH monitoring in the connected mode. The component 198 may be configured to receive, from the network node, an activity indication associated with the first resource for the TRS that indicates an activation or a deactivation of the first resource for the TRS. The component 198 may be configured to receive, from the network node, a selection indication and an index associated with the SSB beam, where the index associated with the SSB beam corresponds to a TCI state configuration, where the selection indication corresponds to the one TRS resource set. The component 198 may be configured to apply the TCI state configuration based on the selection indication and the index associated with the SSB beam. The component 198 may be configured to receive, from the network node, a selection indication and an order value associated with an ordered location of the TRS resource set in the more than one TRS resource set, where the order value associated with the TRS resource set corresponds to a TCI state configuration, where the selection indication corresponds to the TRS resource set. The component 198 may be configured to apply the TCI state configuration based on the selection indication and the order value associated with the TRS resource set. The component 198 may be configured to receive, from the network node, a selection indication and the identifier of the TRS resource set, where the identifier of the TRS resource set corresponds to a TCI state configuration, where the selection indication corresponds to the TRS resource set. The component 198 may be configured to apply the TCI state configuration based on the selection indication and the identifier of the TRS resource set. The component 198 may be configured to communicate, with the network node, based on the first set of TRS measurements for the TRS. The component 198 may be further configured to perform any of the aspects described in connection with the flowcharts in any of FIGS. 9, 10, and/or any of the aspects performed by a UE for any of FIGS. 4-8. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving, from a network node, a first TRS configuration via a SIB. In the configuration, the apparatus 1104, and in particular the cellular baseband processor(s) 1124 and/or the application processor(s) 1106, may include means for monitoring, in a connected mode, a first resource for a TRS based on the first TRS configuration. In the configuration, the apparatus 1104, and in particular the cellular baseband processor(s) 1124 and/or the application processor(s) 1106, may include means for performing a first set of TRS measurements for the TRS. In one configuration, the apparatus 1104, and in particular the cellular baseband processor(s) 1124 and/or the application processor(s) 1106, may include means for receiving, from the network node, a second TRS configuration via RRC signaling. In one configuration, the apparatus 1104, and in particular the cellular baseband processor(s) 1124 and/or the application processor(s) 1106, may include means for refraining from monitoring the first resource indicated in the first TRS configuration. In one configuration, the apparatus 1104, and in particular the cellular baseband processor(s) 1124 and/or the application processor(s) 1106, may include means for monitoring, in the connected mode, a second resource for the TRS based on the second TRS configuration. In one configuration, the apparatus 1104, and in particular the cellular baseband processor(s) 1124 and/or the application processor(s) 1106, may include means for performing a second set of TRS measurements for the TRS based on the monitored second resource. In one configuration, the apparatus 1104, and in particular the cellular baseband processor(s) 1124 and/or the application processor(s) 1106, may include means for receiving, from the network node after the reception of the second TRS configuration, a priority indication that indicates a configuration prioritization associated with the first TRS configuration and the second TRS configuration. In one configuration, the apparatus 1104, and in particular the cellular baseband processor(s) 1124 and/or the application processor(s) 1106, may include means for receiving, from the network node, a second TRS configuration via RRC signaling. In one configuration, the apparatus 1104, and in particular the cellular baseband processor(s) 1124 and/or the application processor(s) 1106, may include means for receiving, from the network node, a priority indication that indicates a configuration prioritization associated with the first TRS configuration and the second TRS configuration. In one configuration, the apparatus 1104, and in particular the cellular baseband processor(s) 1124 and/or the application processor(s) 1106, may include means for receiving, from the network node, a second TRS configuration via RRC signaling, where the second TRS configuration indicates a second resource for the TRS. In one configuration, the apparatus 1104, and in particular the cellular baseband processor(s) 1124 and/or the application processor(s) 1106, may include means for receiving, from the network node, a priority indication that indicates a configuration prioritization associated with the first TRS configuration and the second TRS configuration. In one configuration, the apparatus 1104, and in particular the cellular baseband processor(s) 1124 and/or the application processor(s) 1106, may include means for providing, to the network node, a capability indication of the UE, where the capability indication provides indicia of support of the UE for a PEI and paging PDCCH monitoring in the connected mode. In one configuration, the apparatus 1104, and in particular the cellular baseband processor(s) 1124 and/or the application processor(s) 1106, may include means for receiving, from the network node, an activity indication associated with the first resource for the TRS that indicates an activation or a deactivation of the first resource for the TRS. In one configuration, the apparatus 1104, and in particular the cellular baseband processor(s) 1124 and/or the application processor(s) 1106, may include means for receiving, from the network node, a selection indication and an index associated with the SSB beam, where the index associated with the SSB beam corresponds to a TCI state configuration, where the selection indication corresponds to the one TRS resource set. In one configuration, the apparatus 1104, and in particular the cellular baseband processor(s) 1124 and/or the application processor(s) 1106, may include means for applying the TCI state configuration based on the selection indication and the index associated with the SSB beam. In one configuration, the apparatus 1104, and in particular the cellular baseband processor(s) 1124 and/or the application processor(s) 1106, may include means for receiving, from the network node, a selection indication and an order value associated with an ordered location of the TRS resource set in the more than one TRS resource set, where the order value associated with the TRS resource set corresponds to a TCI state configuration, where the selection indication corresponds to the TRS resource set. In one configuration, the apparatus 1104, and in particular the cellular baseband processor(s) 1124 and/or the application processor(s) 1106, may include means for applying the TCI state configuration based on the selection indication and the order value associated with the TRS resource set. In one configuration, the apparatus 1104, and in particular the cellular baseband processor(s) 1124 and/or the application processor(s) 1106, may include means for receiving, from the network node, a selection indication and the identifier of the TRS resource set, where the identifier of the TRS resource set corresponds to a TCI state configuration, where the selection indication corresponds to the TRS resource set. In one configuration, the apparatus 1104, and in particular the cellular baseband processor(s) 1124 and/or the application processor(s) 1106, may include means for applying the TCI state configuration based on the selection indication and the identifier of the TRS resource set. In one configuration, the apparatus 1104, and in particular the cellular baseband processor(s) 1124 and/or the application processor(s) 1106, may include means for communicating, with the network node, based on the first set of TRS measurements for the TRS. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS. or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′. 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, for a UE, a first TRS configuration, associated with a TRS for a connected mode of the UE, via a SIB. The component 199 may also be configured to communicate, with the UE, based on a first set of TRS measurements for the TRS that is associated with a monitored first resource of the TRS associated with the first TRS configuration. The component 199 may be configured to provide, for the UE, a second TRS configuration via RRC signaling. The component 199 may be configured to communicate, with the UE and absent further communication based on the first set of TRS measurements for the TRS, based on a second set of TRS measurements for the TRS that is associated with a monitored second resource of the TRS associated with the second TRS configuration. The component 199 may be configured to provide, for the UE, a priority indication that indicates a configuration prioritization associated with the first TRS configuration and the second TRS configuration. The component 199 may be configured to provide, for the UE, a second TRS configuration via RRC signaling. The component 199 may be configured to provide, for the UE, a priority indication that indicates a configuration prioritization associated with the first TRS configuration and the second TRS configuration. The component 199 may be configured to provide, for the UE, a second TRS configuration via RRC signaling, where the second TRS configuration indicates a second resource for the TRS. The component 199 may be configured to provide, for the UE, a priority indication that indicates a configuration prioritization associated with the first TRS configuration and the second TRS configuration. The component 199 may be configured to receive, from the UE, a capability indication of the UE, where the capability indication provides indicia of support of the UE for a PEI and paging PDCCH monitoring in the connected mode. The component 199 may be configured to provide, for the UE, an activity indication associated with the first resource for the TRS that indicates an activation or a deactivation of the first resource for the TRS. The component 199 may be configured to configure the UE with a TCI state configuration based on a selection indication and an index associated with the SSB beam by providing, for the UE, the selection indication and the index associated with the SSB beam, where the index associated with the SSB beam corresponds to the TCI state configuration, where the selection indication corresponds to the one TRS resource set. The component 199 may be configured to configure the UE with a TCI state configuration based on a selection indication and an order value associated with the TRS resource set, where to configure the UE with the TCI state configuration, the at least one processor, individually or in any combination, is configured to provide, for the UE, the selection indication and the order value associated with an ordered location of the TRS resource set in the more than one TRS resource set, where the order value associated with the TRS resource set corresponds to the TCI state configuration, where the selection indication corresponds to the TRS resource set. The component 199 may be configured to configure the UE with a TCI state configuration based on a selection indication and the identifier of the TRS resource set by providing, for the UE, the selection indication and the identifier of the TRS resource set, where the identifier of the TRS resource set corresponds to the TCI state configuration, where the selection indication corresponds to the TRS resource set. The component 199 may be further configured to perform any of the aspects described in connection with the flowcharts in any of FIGS. 9, 10, and/or any of the aspects performed by a network node, base station, gNB, etc., for any of FIGS. 4-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for providing, for a UE, a first TRS configuration, associated with a TRS for a connected mode of the UE, via a SIB. In the configuration, the network entity 1202 may include means for communicating, with the UE, based on a first set of TRS measurements for the TRS that is associated with a monitored first resource of the TRS associated with the first TRS configuration. In one configuration, the network entity 1202 may include means for providing, for the UE, a second TRS configuration via RRC signaling. In one configuration, the network entity 1202 may include means for communicating, with the UE and absent further communication based on the first set of TRS measurements for the TRS, based on a second set of TRS measurements for the TRS that is associated with a monitored second resource of the TRS associated with the second TRS configuration. In one configuration, the network entity 1202 may include means for providing, for the UE, a priority indication that indicates a configuration prioritization associated with the first TRS configuration and the second TRS configuration. In one configuration, the network entity 1202 may include means for providing, for the UE, a second TRS configuration via RRC signaling. In one configuration, the network entity 1202 may include means for providing, for the UE, a priority indication that indicates a configuration prioritization associated with the first TRS configuration and the second TRS configuration. In one configuration, the network entity 1202 may include means for providing, for the UE, a second TRS configuration via RRC signaling, where the second TRS configuration indicates a second resource for the TRS. In one configuration, the network entity 1202 may include means for providing, for the UE, a priority indication that indicates a configuration prioritization associated with the first TRS configuration and the second TRS configuration. In one configuration, the network entity 1202 may include means for receiving, from the UE, a capability indication of the UE, where the capability indication provides indicia of support of the UE for a PEI and paging PDCCH monitoring in the connected mode. In one configuration, the network entity 1202 may include means for providing, for the UE, an activity indication associated with the first resource for the TRS that indicates an activation or a deactivation of the first resource for the TRS. In one configuration, the network entity 1202 may include means for configuring the UE with a TCI state configuration based on a selection indication and an index associated with the SSB beam by providing, for the UE, the selection indication and the index associated with the SSB beam, where the index associated with the SSB beam corresponds to the TCI state configuration, where the selection indication corresponds to the one TRS resource set. In one configuration, the network entity 1202 may include means for configuring the UE with a TCI state configuration based on a selection indication and an order value associated with the TRS resource set, where to configure the UE with the TCI state configuration, the at least one processor, individually or in any combination, is configured to provide, for the UE, the selection indication and the order value associated with an ordered location of the TRS resource set in the more than one TRS resource set, where the order value associated with the TRS resource set corresponds to the TCI state configuration, where the selection indication corresponds to the TRS resource set. In one configuration, the network entity 1202 may include means for configuring the UE with a TCI state configuration based on a selection indication and the identifier of the TRS resource set by providing, for the UE, the selection indication and the identifier of the TRS resource set, where the identifier of the TRS resource set corresponds to the TCI state configuration, where the selection indication corresponds to the TRS resource set. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

In wireless communication networks, for communications between network nodes (e.g., base stations, gNBs, etc.) and UEs, a TRS may be used for frequency and time tracking, estimation of channel delay spread and Doppler spread estimation, AGC and power delay profile (PDP) estimation, and/or the like. A TRS may be configured for a connected mode UE. For instance, UEs in RRC connected mode may be expected to receive the higher layer UE specific configuration of an NZP-CSI-RS-ResourceSet configured with a higher layer parameter trs-Info. For idle/inactive mode UEs, a SIB17 can carry cell-specific TRS configuration that can be used by idle/inactive UEs. In some deployments, TRS transmission is cell-specific, although the configuration of TRS may be provided using dedicated RRC signaling to connected UEs. However, TRS transmission that is cell-specific for UEs in the connected mode with a network node and broadcast SIBs carrying TRS information creates wasteful redundancies in wireless transmissions. That is, scenarios arise in which TRS configurations are provided to a UE via a SIB, and then are provided again using dedicated RRC to connected UEs. Provision of the same TRS information multiple times to the same UE increases signaling overhead in wireless communication networks, introduces delay into the networks, and also increases power/processing consumption at UEs and network nodes.

The aspects herein for broadcast TRS configurations enable SIB17-based TRS configuration in the connected mode for UEs, as well as provide for configurations and considerations, such as dynamic reconfiguration due to network/device changes, to improve resource utilization and efficiency. Aspects reduce signaling overhead and power consumption without impacting UE performance by enabling broadcast TRS configuration for UEs in connected mode. Aspects also improve flexibility and efficiency in reconfigurations due to network/device changes by implementing dynamic features of SIB17 to activate/deactivate TRS.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE). comprising: receiving, from a network node, a first tracking reference signal (TRS) configuration via a system information block (SIB); monitoring, in a connected mode, a first resource for a TRS based on the first TRS configuration; and performing a first set of TRS measurements for the TRS.

Aspect 2 is the method of aspect 1, wherein performing the first set of TRS measurements for the TRS includes performing the first set of TRS measurements based on the monitored first resource.

Aspect 3 is the method of any of aspects 1 and 2, further comprising: receiving, from the network node, a second TRS configuration via radio resource control (RRC) signaling; refraining from monitoring the first resource indicated in the first TRS configuration; monitoring, in the connected mode, a second resource for the TRS based on the second TRS configuration; and performing a second set of TRS measurements for the TRS based on the monitored second resource.

Aspect 4 is the method of aspect 3, further comprising: receiving, from the network node after the reception of the second TRS configuration, a priority indication that indicates a configuration prioritization associated with the first TRS configuration and the second TRS configuration; wherein refraining from monitoring the first resource includes refraining from monitoring the first resource based on the configuration prioritization indicated by the priority indication.

Aspect 5 is the method of any of aspects 1 and 2, further comprising: receiving, from the network node, a second TRS configuration via radio resource control (RRC) signaling; and receiving, from the network node, a priority indication that indicates a configuration prioritization associated with the first TRS configuration and the second TRS configuration; wherein monitoring, in the connected mode, the first resource for the TRS based on the first TRS configuration includes monitoring the first resource for the TRS based on the configuration prioritization indicated by the priority indication.

Aspect 6 is the method of aspect 5, wherein receiving the priority indication includes receiving the priority indication via an extension of the SIB, UE-dedicated signaling. or group-common signaling.

Aspect 7 is the method of aspect 6, wherein receiving the priority indication includes receiving the priority indication semi-statically or dynamically.

Aspect 8 is the method of any of aspects 1 and 2, further comprising: receiving, from the network node, a second TRS configuration via radio resource control (RRC) signaling, wherein the second TRS configuration indicates a second resource for the TRS; receiving, from the network node, a priority indication that indicates a configuration prioritization associated with the first TRS configuration and the second TRS configuration; wherein monitoring, in the connected mode, the first resource for the TRS based on the first TRS configuration includes monitoring the second resource for the TRS based on the second TRS configuration according to the priority indication; and wherein performing the first set of TRS measurements for the TRS includes performing the first set of TRS measurements for the TRS based on the monitored first resource and performing a second set of TRS measurements for the TRS based on the monitored second resource.

Aspect 9 is the method of aspect 8, wherein the priority indication includes a first indication of a first beam direction associated with the first TRS configuration and a second indication of a second beam direction associated with the second TRS configuration.

Aspect 10 is the method of any of aspects 1 and 2, wherein monitoring, in the connected mode, the first resource for the TRS based on the first TRS configuration includes monitoring, in the connected mode, the first resource for the TRS based on a periodicity of the TRS.

Aspect 11 is the method of aspect 10, wherein the periodicity of the TRS is based on at least one of: an absence of a second TRS configuration, from the network node, via radio resource control (RRC) signaling, or a periodicity indication from the network node that indicates the periodicity of the TRS.

Aspect 12 is the method of any of aspects 1 and 2, further comprising: providing, to the network node, a capability indication of the UE, wherein the capability indication provides indicia of support of the UE for a paging error indication (PEI) and paging physical downlink control channel (PDCCH) monitoring in the connected mode; and receiving, from the network node, an activity indication associated with the first resource for the TRS that indicates an activation or a deactivation of the first resource for the TRS.

Aspect 13 is the method of aspect 12, wherein the activity indication includes a single bit that indicates the activation or the deactivation, wherein receiving the activity indication includes receiving the activity indication via the SIB or radio resource control (RRC) signaling; or wherein the activity indication includes a validity duration extension that indicates an extended time period for which a first TRS resource set that includes the first resource of the TRS is activated.

Aspect 14 is the method of aspect 13, wherein the extended time period is different from at least one of: a first time period associated with a first activation of a second TRS resource set that excludes the first resource of the TRS; or a second time period associated with a second activation of a third TRS resource set of a different UE in an idle mode.

Aspect 15 is the method of aspect 12, wherein receiving the activity indication associated with the first resource for the TRS includes receiving, based on the capability indication of the UE indicating a lack of the support, the activity indication associated with the first resource for the TRS via unicast or group-common downlink control information (DCI) or via a unicast or multi-cast medium access control (MAC) control element (MAC-CE).

Aspect 16 is the method of any of aspects 1 and 2, wherein the first TRS configuration indicates at most one TRS resource set is associated with a synchronization signal block (SSB) beam, wherein the at most one TRS resource set includes the first resource; the method further comprising: receiving, from the network node, a selection indication and an index associated with the SSB beam, wherein the index associated with the SSB beam corresponds to a transmission configuration indication (TCI) state configuration, wherein the selection indication corresponds to the at most one TRS resource set; and applying the TCI state configuration based on the selection indication and the index associated with the SSB beam.

Aspect 17 is the method of any of aspects 1 and 2, wherein the first TRS configuration indicates more than one TRS resource set is associated with a synchronization signal block (SSB) beam, wherein a TRS resource set of the more than one TRS resource set includes the first resource; the method further comprising: receiving, from the network node, a selection indication and an order value associated with an ordered location of the TRS resource set in the more than one TRS resource set, wherein the order value associated with the TRS resource set corresponds to a transmission configuration indication (TCI) state configuration, wherein the selection indication corresponds to the TRS resource set; and applying the TCI state configuration based on the selection indication and the order value associated with the TRS resource set.

Aspect 18 is the method of any of aspects 1 and 2, wherein the first TRS configuration indicates an identifier of a TRS resource set that includes the first resource; the method further comprising: receiving, from the network node, a selection indication and the identifier of the TRS resource set, wherein the identifier of the TRS resource set corresponds to a transmission configuration indication (TCI) state configuration, wherein the selection indication corresponds to the TRS resource set; and applying the TCI state configuration based on the selection indication and the identifier of the TRS resource set.

Aspect 19 is the method of any of aspects 1 to 18, further comprising: communicating, with the network node, based on the first set of TRS measurements for the TRS.

Aspect 20 is a method of wireless communication at a network node, comprising: providing, for a user equipment (UE), a first tracking reference signal (TRS) configuration, associated with a TRS for a connected mode of the UE, via a system information block (SIB); and communicating, with the UE, based on a first set of TRS measurements for the TRS that is associated with a monitored first resource of the TRS associated with the first TRS configuration.

Aspect 21 is the method of aspect 20, further comprising: providing, for the UE, a second TRS configuration via radio resource control (RRC) signaling; and communicating, with the UE and absent further communication based on the first set of TRS measurements for the TRS, based on a second set of TRS measurements for the TRS that is associated with a monitored second resource of the TRS associated with the second TRS configuration.

Aspect 22 is the method of aspect 21, further comprising: providing, for the UE, a priority indication that indicates a configuration prioritization associated with the first TRS configuration and the second TRS configuration; wherein communicating, with the UE and absent the further communication based on the first set of TRS measurements for the TRS, includes communicating based on the second set of TRS measurements for the TRS is based on the priority indication.

Aspect 23 is the method of aspect 20, further comprising: providing, for the UE, a second TRS configuration via radio resource control (RRC) signaling; and providing. for the UE, a priority indication that indicates a configuration prioritization associated with the first TRS configuration and the second TRS configuration; wherein communicating, with the UE, based on the first set of TRS measurements for the TRS based on the monitored first resource of the TRS associated with the first TRS configuration includes communicating based on the first set of TRS measurements and also based on the priority indication.

Aspect 24 is the method of aspect 20, further comprising: providing, for the UE, a second TRS configuration via radio resource control (RRC) signaling, wherein the second TRS configuration indicates a second resource for the TRS; providing, for the UE, a priority indication that indicates a configuration prioritization associated with the first TRS configuration and the second TRS configuration; wherein communicating, with the UE, based on the first set of TRS measurements for the TRS that is associated with the monitored first resource of the TRS associated with the first TRS configuration includes communicating based on a second set of TRS measurements for the TRS associated with a monitored second resource of the TRS associated with the second TRS configuration according to the priority indication.

Aspect 25 is the method of aspect 20, further comprising: receiving, from the UE, a capability indication of the UE, wherein the capability indication provides indicia of support of the UE for a paging error indication (PEI) and paging physical downlink control channel (PDCCH) monitoring in the connected mode; and providing, for the UE, an activity indication associated with the first resource for the TRS that indicates an activation or a deactivation of the first resource for the TRS; wherein the activity indication includes a single bit that indicates the activation or the deactivation, wherein receiving the activity indication includes receiving the activity indication via the SIB or radio resource control (RRC) signaling, wherein the activity indication includes a validity duration extension that indicates an extended time period for which a first TRS resource set that includes the first resource of the TRS is activated, wherein the extended time period is different from at least one of (i) a first time period associated with a first activation of a second TRS resource set that excludes the first resource of the TRS, or (ii) a second time period associated with a second activation of a third TRS resource set of a different UE in an idle mode, or wherein receiving the activity indication associated with the first resource for the TRS includes receiving, based on the capability indication of the UE indicating a lack of the support, the activity indication associated with the first resource for the TRS via unicast or group-common downlink control information (DCI) or via a unicast or multi-cast medium access control (MAC) control element (MAC-CE).

Aspect 26 is the method of aspect 20, wherein the first TRS configuration indicates at most one TRS resource set is associated with a synchronization signal block (SSB) beam, wherein the at most one TRS resource set includes the first resource; the method further comprising: configuring the UE with a transmission configuration indication (TCI) state configuration based on a selection indication and an index associated with the SSB beam by providing, for the UE, the selection indication and the index associated with the SSB beam, wherein the index associated with the SSB beam corresponds to the TCI state configuration, wherein the selection indication corresponds to the at most one TRS resource set.

Aspect 27 is the method of aspect 20, wherein the first TRS configuration indicates more than one TRS resource set is associated with a synchronization signal block (SSB) beam, wherein a TRS resource set of the more than one TRS resource set includes the first resource; the method further comprising: configuring the UE with a transmission configuration indication (TCI) state configuration based on a selection indication and an order value associated with the TRS resource set by providing, for the UE, the selection indication and the order value associated with an ordered location of the TRS resource set in the more than one TRS resource set, wherein the order value associated with the TRS resource set corresponds to the TCI state configuration, wherein the selection indication corresponds to the TRS resource set.

Aspect 28 is the method of aspect 20, wherein the first TRS configuration indicates an identifier of a TRS resource set that includes the first resource; the method further comprising: configuring the UE with a transmission configuration indication (TCI) state configuration based on a selection indication and the identifier of the TRS resource set by providing, for the UE, the selection indication and the identifier of the TRS resource set, wherein the identifier of the TRS resource set corresponds to the TCI state configuration, wherein the selection indication corresponds to the TRS resource set.

Aspect 29 is an apparatus for wireless communication including means for implementing any of aspects 1 to 19.

Aspect 30 is a computer-readable medium (e.g., a non-transitory computer-readable medium) storing computer executable code, the code when executed by at least one processor causes the at least one processor to implement any of aspects 1 to 19.

Aspect 31 is an apparatus for wireless communication at a network node. The apparatus includes a memory; and at least one processor coupled to the memory and, based at least in part on information stored in the memory, the at least one processor is configured to implement any of aspects 1 to 19.

Aspect 32 is the apparatus of aspect 31, further including at least one of a transceiver or an antenna coupled to the at least one processor.

Aspect 33 is an apparatus for wireless communication including means for implementing any of aspects 20 to 28.

Aspect 34 is a computer-readable medium (e.g., a non-transitory computer-readable medium) storing computer executable code, the code when executed by at least one processor causes the at least one processor to implement any of aspects 20 to 28.

Aspect 35 is an apparatus for wireless communication at a network node. The apparatus includes a memory; and at least one processor coupled to the memory and, based at least in part on information stored in the memory, the at least one processor is configured to implement any of aspects 20 to 28.

Aspect 36 is the apparatus of aspect 35, further including at least one of a transceiver or an antenna coupled to the at least one processor.

Aspect 37 is an apparatus for wireless communication at a user equipment (UE), comprising: at least one memory; and at least one processor coupled to the at least one memory and, based at least in part on information stored in the at least one memory, the at least one processor, individually or in any combination, is configured to perform the method of any of aspects 1 to 19.

Aspect 38 is an apparatus for wireless communication at a user equipment (UE), comprising means for performing each step in the method of any of aspects 1 to 19.

Aspect 39 is the apparatus of any of aspects 37 and 38, further comprising a transceiver configured to receive or to transmit in association with the method of any of aspects 1 to 19.

Aspect 40 is a computer-readable medium storing computer executable code at a user equipment (UE), the code when executed by at least one processor causes the at least one processor to perform the method of any of aspects 1 to 19.

Aspect 41 is an apparatus for wireless communication at a network node, comprising: at least one memory; and at least one processor coupled to the at least one memory and, based at least in part on information stored in the at least one memory, the at least one processor, individually or in any combination, is configured to perform the method of any of aspects 20 to 28.

Aspect 42 is an apparatus for wireless communication at network node, comprising means for performing each step in the method of any of aspects 20 to 28.

Aspect 43 is the apparatus of any of aspects 41 and 42, further comprising a transceiver configured to receive or to transmit in association with the method of any of aspects 20 to 28.

Aspect 44 is a computer-readable medium storing computer executable code at network node, the code when executed by at least one processor causes the at least one processor to perform the method of any of aspects 20 to 28.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, a first tracking reference signal (TRS) configuration via a system information block (SIB);
monitor, in a connected mode, a first resource for a TRS based on the first TRS configuration; and
perform a first set of TRS measurements for the TRS.

2. The apparatus of claim 1, wherein to perform the first set of TRS measurements for the TRS, the at least one processor, individually or in any combination, is configured to perform the first set of TRS measurements based on the monitored first resource.

3. The apparatus of claim 1, wherein the at least one processor, individually or in any combination, is further configured to:
receive, from the network node, a second TRS configuration via radio resource control (RRC) signaling;
refrain from monitoring the first resource indicated in the first TRS configuration;
monitor, in the connected mode, a second resource for the TRS based on the second TRS configuration; and
perform a second set of TRS measurements for the TRS based on the monitored second resource.

4. The apparatus of claim 3, wherein the at least one processor, individually or in any combination, is further configured to:
receive, from the network node after the reception of the second TRS configuration, a priority indication that indicates a configuration prioritization associated with the first TRS configuration and the second TRS configuration;
wherein to refrain from monitoring the first resource indicated in the first TRS configuration, the at least one processor, individually or in any combination, is configured to refrain from monitoring the first resource based on the configuration prioritization indicated by the priority indication.

5. The apparatus of claim 1, wherein the at least one processor, individually or in any combination, is further configured to:
receive, from the network node, a second TRS configuration via radio resource control (RRC) signaling; and
receive, from the network node, a priority indication that indicates a configuration prioritization associated with the first TRS configuration and the second TRS configuration;
wherein to monitor, in the connected mode, the first resource for the TRS based on the first TRS configuration, the at least one processor, individually or in any combination, is configured to monitor the first resource for the TRS based on the configuration prioritization indicated by the priority indication.

6. The apparatus of claim 5, wherein to receive the priority indication, the at least one processor, individually or in any combination, is configured to receive the priority indication via an extension of the SIB, UE-dedicated signaling, or group-common signaling.

7. The apparatus of claim 6, wherein to receive the priority indication, the at least one processor, individually or in any combination, is configured to receive the priority indication semi-statically or dynamically.

8. The apparatus of claim 1, wherein the at least one processor, individually or in any combination, is further configured to:
receive, from the network node, a second TRS configuration via radio resource control (RRC) signaling, wherein the second TRS configuration indicates a second resource for the TRS; and
receive, from the network node, a priority indication that indicates a configuration prioritization associated with the first TRS configuration and the second TRS configuration;
wherein to monitor, in the connected mode, the first resource for the TRS based on the first TRS configuration, the at least one processor, individually or in any combination, is configured to monitor the second resource for the TRS based on the second TRS configuration according to the priority indication;
wherein to perform the first set of TRS measurements for the TRS, the at least one processor, individually or in any combination, is configured to perform the first set of TRS measurements for the TRS based on the monitored first resource and to perform a second set of TRS measurements for the TRS based on the monitored second resource.

9. The apparatus of claim 8, wherein the priority indication includes a first indication of a first beam direction associated with the first TRS configuration and a second indication of a second beam direction associated with the second TRS configuration.

10. The apparatus of claim 1, wherein to monitor, in the connected mode, the first resource for the TRS based on the first TRS configuration, the at least one processor, individually or in any combination, is configured to monitor, in the connected mode, the first resource for the TRS based on a periodicity of the TRS.

11. The apparatus of claim 10, wherein the periodicity of the TRS is based on at least one of:
an absence of a second TRS configuration, from the network node, via radio resource control (RRC) signaling, or
a periodicity indication from the network node that indicates the periodicity of the TRS.

12. The apparatus of claim 1, wherein the at least one processor, individually or in any combination, is further configured to:
provide, to the network node, a capability indication of the UE, wherein the capability indication provides indicia of support of the UE for a paging error indication (PEI) and paging physical downlink control channel (PDCCH) monitoring in the connected mode; and
receive, from the network node, an activity indication associated with the first resource for the TRS that indicates an activation or a deactivation of the first resource for the TRS.

13. The apparatus of claim 12, wherein the activity indication includes a single bit that indicates the activation or the deactivation, wherein to receive the activity indication, the at least one processor, individually or in any combination, is configured to receive the activity indication via the SIB or radio resource control (RRC) signaling; or
wherein the activity indication includes a validity duration extension that indicates an extended time period for which a first TRS resource set that includes the first resource of the TRS is activated.

14. The apparatus of claim 13, wherein the extended time period is different from at least one of:
a first time period associated with a first activation of a second TRS resource set that excludes the first resource of the TRS; or
a second time period associated with a second activation of a third TRS resource set of a different UE in an idle mode.

15. The apparatus of claim 12, wherein to receive the activity indication associated with the first resource for the TRS, the at least one processor, individually or in any combination, is configured to receive, based on the capability indication of the UE indicating a lack of the support, the activity indication associated with the first resource for the TRS via unicast or group-common downlink control information (DCI) or via a unicast or multi-cast medium access control (MAC) control element (MAC-CE).

16. The apparatus of claim 1, wherein the first TRS configuration indicates at most one TRS resource set is associated with a synchronization signal block (SSB) beam, wherein the at most one TRS resource set includes the first resource;
wherein the at least one processor, individually or in any combination, is further configured to:
receive, from the network node, a selection indication and an index associated with the SSB beam, wherein the index associated with the SSB beam corresponds to a transmission configuration indication (TCI) state configuration, wherein the selection indication corresponds to the at most one TRS resource set; and
apply the TCI state configuration based on the selection indication and the index associated with the SSB beam.

17. The apparatus of claim 1, wherein the first TRS configuration indicates more than one TRS resource set is associated with a synchronization signal block (SSB) beam, wherein a TRS resource set of the more than one TRS resource set includes the first resource;
wherein the at least one processor, individually or in any combination, is further configured to:
receive, from the network node, a selection indication and an order value associated with an ordered location of the TRS resource set in the more than one TRS resource set, wherein the order value associated with the TRS resource set corresponds to a transmission configuration indication (TCI) state configuration, wherein the selection indication corresponds to the TRS resource set; and
apply the TCI state configuration based on the selection indication and the order value associated with the TRS resource set.

18. The apparatus of claim 1, wherein the first TRS configuration indicates an identifier of a TRS resource set that includes the TRS resource;
wherein the at least one processor, individually or in any combination, is further configured to:
receive, from the network node, a selection indication and the identifier of the TRS resource set, wherein the identifier of the TRS resource set corresponds to a transmission configuration indication (TCI) state configuration, wherein the selection indication corresponds to the TRS resource set; and
apply the TCI state configuration based on the selection indication and the identifier of the TRS resource set.

19. The apparatus of claim 1, wherein the at least one processor, individually or in any combination, is further configured to:
communicate, with the network node, based on the first set of TRS measurements for the TRS.

20. An apparatus for wireless communication at a network node, comprising:
at least one memory; and
at least one processor coupled to the at least one memory and, based at least in part on information stored in the at least one memory, the at least one processor, individually or in any combination, is configured to:
provide, for a user equipment (UE), a first tracking reference signal (TRS) configuration, associated with a TRS for a connected mode of the UE, via a system information block (SIB); and
communicate, with the UE, based on a first set of TRS measurements for the TRS that is associated with a monitored first resource of the TRS associated with the first TRS configuration.

21. The apparatus of claim 20, wherein the at least one processor, individually or in any combination, is further configured to:
provide, for the UE, a second TRS configuration via radio resource control (RRC) signaling; and
communicate, with the UE and absent further communication based on the first set of TRS measurements for the TRS, based on a second set of TRS measurements for the TRS that is associated with a monitored second resource of the TRS associated with the second TRS configuration.

22. The apparatus of claim 21, wherein the at least one processor, individually or in any combination, is further configured to:
provide, for the UE, a priority indication that indicates a configuration prioritization associated with the first TRS configuration and the second TRS configuration;
wherein to communicate, with the UE and absent the further communication based on the first set of TRS measurements for the TRS, based on the second set of TRS measurements for the TRS, the at least one processor, individually or in any combination, is configured to communicate based on the second set of TRS measurements for the TRS based on the priority indication.

23. The apparatus of claim 20, wherein the at least one processor, individually or in any combination, is further configured to:
provide, for the UE, a second TRS configuration via radio resource control (RRC) signaling; and
provide, for the UE, a priority indication that indicates a configuration prioritization associated with the first TRS configuration and the second TRS configuration;
wherein to communicate, with the UE, based on the first set of TRS measurements for the TRS that is associated with the monitored first resource of the TRS associated with the first TRS configuration, the at least one processor, individually or in any combination, is configured to communicate based on the first set of TRS measurements for the TRS and also based on the priority indication.

24. The apparatus of claim 20, wherein the at least one processor, individually or in any combination, is further configured to:
provide, for the UE, a second TRS configuration via radio resource control (RRC) signaling, wherein the second TRS configuration indicates a second resource for the TRS; and
provide, for the UE, a priority indication that indicates a configuration prioritization associated with the first TRS configuration and the second TRS configuration;
wherein to communicate, with the UE, based on the first set of TRS measurements for the TRS that is associated with the monitored first resource of the TRS associated with the first TRS configuration, the at least one processor, individually or in any combination, is configured to communicate based on a second set of TRS measurements for the TRS associated with a monitored second resource of the TRS associated with the second TRS configuration according to the priority indication.

25. The apparatus of claim 20, wherein the at least one processor, individually or in any combination, is further configured to:
receive, from the UE, a capability indication of the UE, wherein the capability indication provides indicia of support of the UE for a paging error indication (PEI) and paging physical downlink control channel (PDCCH) monitoring in the connected mode; and
provide, for the UE, an activity indication associated with the monitored first resource for the TRS that indicates an activation or a deactivation of the monitored first resource for the TRS;
wherein the activity indication includes a single bit that indicates the activation or the deactivation, wherein to receive the activity indication, the at least one processor, individually or in any combination, is configured to receive the activity indication via the SIB or radio resource control (RRC) signaling,
wherein the activity indication includes a validity duration extension that indicates an extended time period for which a first resource set that includes the monitored first resource of the TRS is activated, wherein the extended time period is different from at least one of (i) a first time period associated with a first activation of a second TRS resource set that excludes the monitored first resource of the TRS, or (ii) a second time period associated with a second activation of a third TRS resource set of a different UE in an idle mode, or
wherein to receive the activity indication associated with the monitored first resource for the TRS, the at least one processor, individually or in any combination, is configured to receive, based on the capability indication of the UE indicating a lack of the support, the activity indication associated with the monitored first resource for the TRS via unicast or group-common downlink control information (DCI) or via a unicast or multi-cast medium access control (MAC) control element (MAC-CE).

26. The apparatus of claim 20, wherein the first TRS configuration indicates at most one TRS resource set is associated with a synchronization signal block (SSB) beam, wherein the at most one TRS resource set includes the monitored first resource;
wherein the at least one processor, individually or in any combination, is further configured to:
configure the UE with a transmission configuration indication (TCI) state configuration based on a selection indication and an index associated with the SSB beam by providing, for the UE, the selection indication and the index associated with the SSB beam, wherein the index associated with the SSB beam corresponds to the TCI state configuration, wherein the selection indication corresponds to the at most one TRS resource set.

27. The apparatus of claim 20, wherein the first TRS configuration indicates more than one TRS resource set is associated with a synchronization signal block (SSB) beam, wherein a TRS resource set of the more than one TRS resource set includes the monitored first resource;
wherein the at least one processor, individually or in any combination, is further configured to:
configure the UE with a transmission configuration indication (TCI) state configuration based on a selection indication and an order value associated with the TRS resource set, wherein to configure the UE with the TCI state configuration, the at least one processor, individually or in any combination, is configured to provide, for the UE, the selection indication and the order value associated with an ordered location of the TRS resource set in the more than one TRS resource set, wherein the order value associated with the TRS resource set corresponds to the TCI state configuration, wherein the selection indication corresponds to the TRS resource set.

28. The apparatus of claim 20, wherein the first TRS configuration indicates an identifier of a TRS resource set that includes the monitored first resource;
wherein the at least one processor, individually or in any combination, is further configured to:
configure the UE with a transmission configuration indication (TCI) state configuration based on a selection indication and the identifier of the TRS resource set by providing, for the UE, the selection indication and the identifier of the TRS resource set, wherein the identifier of the TRS resource set corresponds to the TCI state configuration, wherein the selection indication corresponds to the TRS resource set.

29. A method of wireless communication at a user equipment (UE), comprising:
receiving, from a network node, a first tracking reference signal (TRS) configuration via a system information block (SIB);
monitoring, in a connected mode, a first resource for a TRS based on the first TRS configuration; and
performing a first set of TRS measurements for the TRS.

30. A method of wireless communication at a network node, comprising:
providing, for a user equipment (UE), a first tracking reference signal (TRS) configuration, associated with a TRS for a connected mode of the UE, via a system information block (SIB); and
communicating, with the UE, based on a first set of TRS measurements for the TRS that is associated with a monitored first resource of the TRS associated with the first TRS configuration.
